(19) United States
(12) Patent Application Publication
(10) Pub. No.: US 2013/0246145 A1
(43) Pub. Date: Sep. 19, 2013

(54) CARD LINKING

(71) Applicants: Erich L. Ringewald, Belvedere, CA (US); Amit Gaur, San Francisco, CA (US)

(72) Inventors: Erich L. Ringewald, Belvedere, CA (US); Amit Gaur, San Francisco, CA (US)

(73) Assignee: Boku, Inc., San Francisco, CA (US)

(21) Appl. No.: 13/489,323

(22) Filed: Jun. 5, 2012

Related U.S. Application Data
(63) Continuation-in-part of application No. 13/423,853, filed on Mar. 19, 2012.

(51) Int. Cl. G06Q 20/36

(52) U.S. Cl. CPC G06Q 20/36
USPC 705/14.23; 705/41

(57) ABSTRACT

A computer-based system for managing electronic transactions is described. A plurality of first card numbers is received over a network interface device. Each respective first card number is stored in a data store in association with a respective consumer account. A charge advisory is received over the network interface device, the charge advisory including a charge advisory card number. A selected one of the consumer accounts is identified by associating one of the first card numbers with the second card number. The charge advisory is processed based on an account detail of the selected consumer account.

### CROSS-REFERENCE TO RELATED APPLICATIONS

This is a continuation-in-part of prior U.S. patent application Ser. No. 13/423,853, filed on Mar. 19, 2012, all of which is incorporated herein by reference in its entirety.

### BACKGROUND OF THE INVENTION

1). Field of the Invention

This invention relates generally to a transactions network and to a method and system for managing electronic transactions.

2). Discussion of Related Art

A customer who visits a store often uses a point-of-sale instrument such as a bank card or a credit card to pay for an item or items that are being purchased. The point-of-sale instrument communicates with a point-of-sale device such as a credit card reader. The point-of-sale device forms part of a point-of-sale network that communicates a charge request to a merchant acquirer computer system and the merchant acquirer computer system routes the charge to credit card and issuer computer systems forming part of the point-of-sale network. The credit card and issuer computer systems may for example include a credit card account to which an amount recorded on the point-of-sale device can be charged if sufficient funds or credit are available. The credit card and issuer computer systems then return a confirmation through the merchant acquirer computer system to the point-of-sale device that the transaction is good, whereafter an operator of the point-of-sale device will allow the customer to leave the store with the item or items that are being purchased.

Electronic transactions can be conducted in a similar manner. In the case of electronic transactions, a user can enter details of a point-of-sale instrument into an interface. Once the details are received, a charge request can be transmitted to a merchant acquirer computer system, and then be processed in a similar manner.

### SUMMARY OF THE INVENTION

The invention provides a computer system for managing electronic transactions, including a server computer system including a processor, a computer-readable medium connected to the processor, a network interface device connected to the processor and a set of instructions on the computer-readable medium, the set of instructions being executable by the processor. The set of instructions includes a data store, a consumer account setup module that receives a plurality of first card numbers over the network interface device and stores each respective first card number in the data store in association with a respective consumer account, a communication and routing module that receives a charge advisory over the network interface device, the charge advisory including a charge advisory card number and identifies a selected one of the consumer accounts by associating one of the first card numbers with the charge advisory card number and a transaction processing system that processes the charge advisory based on an account detail of the selected consumer account.

The invention further provides a computer-based method of managing electronic transactions, including receiving, with a processor, a plurality of first card numbers over a network interface device, storing, with the processor, each respective first card number in a data store in association with a respective consumer account, receiving, with the processor, a charge advisory over the network interface device, the charge advisory including a charge advisory card number, identifying, with the processor, a selected one of the consumer accounts by associating one of the first card numbers with the charge advisory card number and processing, with the processor, the charge advisory based on an account detail of the selected consumer account.

### BRIEF DESCRIPTION OF THE DRAWINGS

The invention is further described by way of example with reference to the accompanying drawings, wherein:

FIG. 1 is a block diagram of a transactions network according to an embodiment of the invention;

FIG. 2 is a block diagram of a mobile device, consumer account setup module, and consumer account forming part of the transactions network;

FIG. 3 is a block diagram illustrating a PAN list update system and a PAN list maintenance system of server and merchant acquirer computer systems forming part of the transactions network;

FIG. 4 is a block diagram of components of the server computer system and an offer network integration unit of the merchant acquirer computer system;

FIG. 5A is a view that is displayed in an interface of the mobile device to prompt a consumer to register a consumer account or to log into an existing account;

FIGS. 5B and 5C are views similar to FIG. 5A wherein the consumer registers a new account;

FIGS. 5D and 5E are views similar to FIG. 5A wherein the consumer logs into an existing consumer account;

FIG. 5F is a view similar to FIG. 5A wherein the consumer stores bank account details for the consumer account;

FIG. 5G is a view that is displayed upon successful login and after bank account details are stored;

FIG. 5H is a view similar to FIG. 5G displaying links to all accounts that have been stored by the consumer;

FIG. 5I is a view similar to FIG. 5H that is displayed for the consumer to enter details of a further bank account;

FIG. 5J is a view similar to FIG. 5H displaying a second bank account;

FIG. 5K is a view similar to FIG. 5A? wherein the consumer can enter preferences and details;

FIG. 6 is a block diagram of a merchant account, a merchant account management system and a merchant computer system, forming part of the transactions network;

FIG. 7A is a screenshot that appears within a browser of the merchant computer system for the merchant to log into the account;

FIG. 7B is a view similar to FIG. 7A permitting the merchant to enter initial details of a voucher, including a discount amount and start and end date;

FIG. 7C is a view similar to FIG. 7B where the merchant can upload a voucher image;

FIG. 7D is a view similar to FIG. 7C where the merchant can select specific terminals or groups of terminals where the offer will be valid;

FIG. 7E is a view similar to FIG. 7D where the merchant can view the offer before approving the offer;

FIG. 7F is a view similar to FIG. 7E after the offer has been approved by the merchant;

FIG. 7G is a view similar to FIG. 7F displaying multiple campaigns based on the merchant account;

FIG. 7H is a view similar to FIG. 7F displaying selection of filter attributes by a merchant;

FIG. 7I is a view similar to FIG. 7H displaying entry of a bid by the merchant;

FIG. 7J is a view similar to FIG. 7I where the merchant selects specific targeting goals;

FIG. 7K is a view similar to FIG. 7J displaying selection of a payment method by the merchant;

FIG. 8 is a block diagram illustrating multiple merchant accounts and a voucher management system for purposes of managing transactions based on voucher entries;

FIGS. 9A and 9B are views that are displayed to the consumer of vouchers and specifics of vouchers, respectively;

FIG. 10 is a block diagram of a point-of-sale instrument for making a purchase at a point-of-sale device;

FIGS. 11A and 11B illustrate computer systems of a point-of-sale network forming part of the transactions network wherein one of the network computer systems operates respectively in a standard mode and in a discount checking mode;

FIG. 12 is a block diagram illustrating a point-of-sale instrument, a point-of-sale network, and a transaction clearing system of the transactions network;

FIG. 13 is a block diagram illustrating the consumer account and other components of preceding drawings that are used for processing a transaction against the consumer account;

FIGS. 14A and 14B illustrate notifications that are displayed on the interface of the mobile device after a transaction has been processed, and a discount has been applied;

FIG. 15 is a view that is displayed in the mobile device of transactions for which the account has been used;

FIG. 16 is a view similar to FIG. 15 of categories of transactions;

FIG. 17 is a view similar to FIG. 15 of one category of transactions;

FIG. 18 is a block diagram illustrating an advertisement trigger system and decision module for pushing offers to the mobile device;

FIG. 19 is a view that is displayed at the mobile device of an advertisement message;

FIG. 20 is a block diagram of a machine in the form of a computer system forming part of the transactions network; and

FIG. 21 is a block diagram of the mobile device illustrating SmartPhone features thereof.

### DETAILED DESCRIPTION OF THE INVENTION

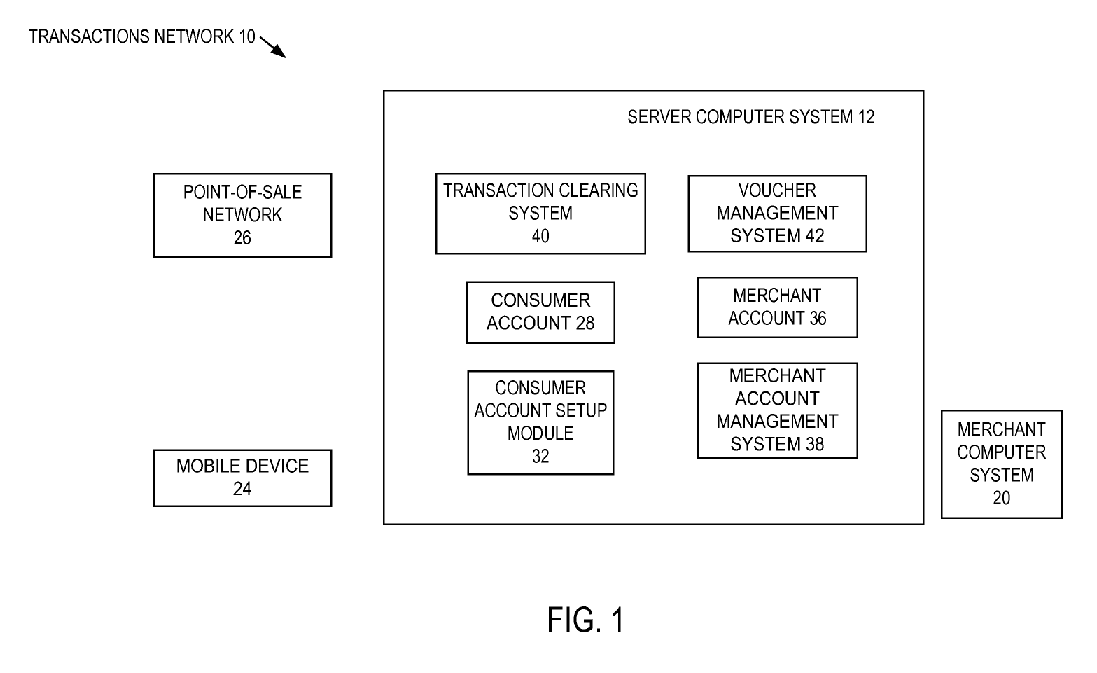

FIG. 1 of the accompanying drawings illustrates a transactions network 10, according to an embodiment of the invention, including a server computer system 12, a merchant computer system 20, a consumer device in the form of a mobile device 24, and a point-of-sale network 26.

The server computer system 12 includes a plurality of consumer accounts (only one consumer account 28 shown), a consumer account setup module 32, a plurality of merchant accounts (only one merchant account 36 shown), a merchant account management system 38, a transaction clearing system 40 and a voucher management system 42.

### 1). Mobile Application

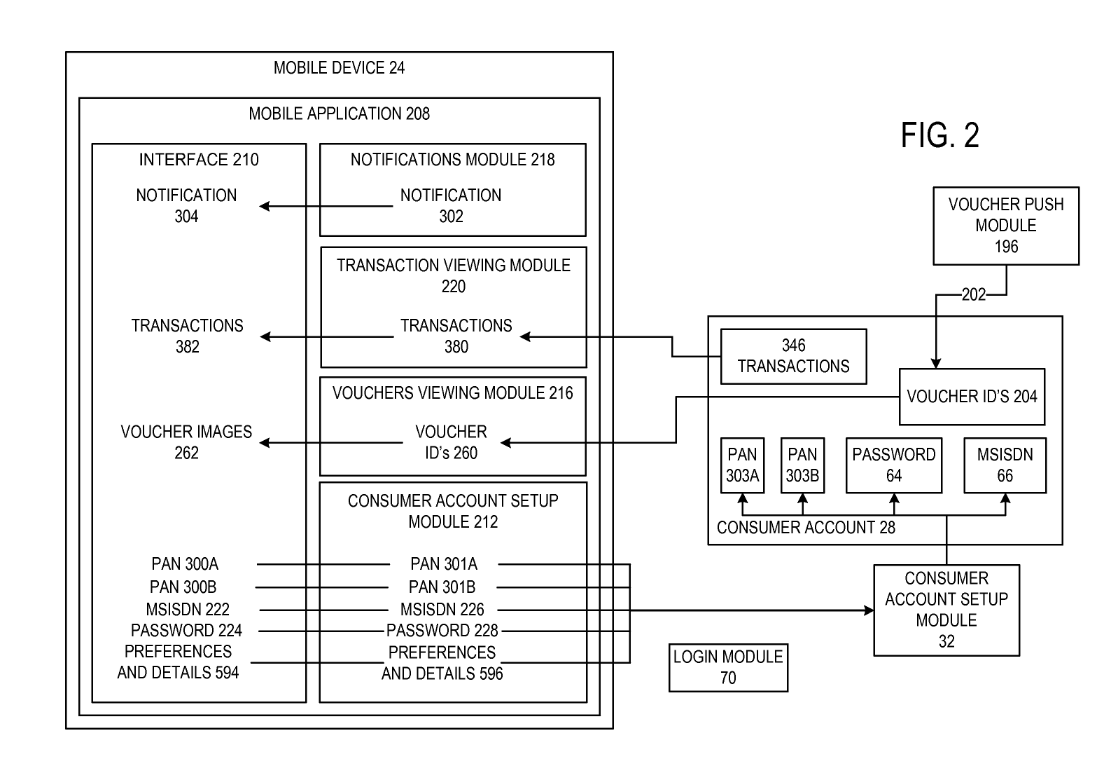

As shown in FIG. 2, the mobile device 24 includes a mobile application 208. The mobile application 208 has an interface 210, a consumer account setup module 212, a vouchers viewing module 216, a notifications module 218, and a transaction viewing module 220.

### 2). Consumer Accounts

The mobile application 208 is initially downloaded directly from the server computer system 12. In such a scenario, the server computer system 12 transmits the mobile application 208 directly to the mobile device 24. In another scenario, the server computer system 12 transmits the mobile application 208 to a host computer system having an application store and a consumer holding the mobile device 24 downloads the mobile application 208 from the application store.

When the mobile application 208 is initially downloaded onto the mobile device 24, a consumer is provided access to the consumer account setup module 212. The consumer can enter a Mobile Subscriber Integrated Services Digital Network Number (MSISDN) 222, a password 224 and a 16 digit primary account number (PAN) 300A and a PAN 300B into the interface 210. The MSISDN 222, the password 224 and PANs 300A and B are received as a MSISDN 226, a password 228 and a PANs 301A and B within the consumer account setup module 212 and are transmitted by the consumer account setup module 212 to the consumer account setup module 32.

The consumer account setup module 32 then establishes one consumer account 28 with a password 64 corresponding to the password 228, a MSISDN 66 corresponding to the MSISDN 226 and PANs 303A and B corresponding to the PANs 301A and B respectively. The MSISDN's 66 and the PANs 303A and B can each independently serve as consumer account identifiers for the respective consumer account 28. Each consumer account 28 will therefore have a different MSISDN 66 and PANs 303A and B. The consumer can also enter preferences and details 594 into the interface 210, which is received by the consumer account setup module 212 as preferences and details 596. The preferences and details 596 are transmitted to the consumer account setup module 32.

The system further includes a login module 70. A consumer at the mobile device 24 in FIG. 2 can enter a password and a MSISDN into the interface 210. The password and the MSISDN are transmitted from the mobile device 24 and are received by the login module 70. The login module 70 then compares the password with the password 64 of the consumer account 28 and compares the MSISDN with the MSISDN 66 of the consumer account 28. Upon a favorable comparison of the passwords and the MSISDN's, the login module 70 then authorizes access to the consumer account 28 having the respective MSISDN 66. The authorization is thus not provided to the mobile device 24 upon an unfavorable login through the login module 70.

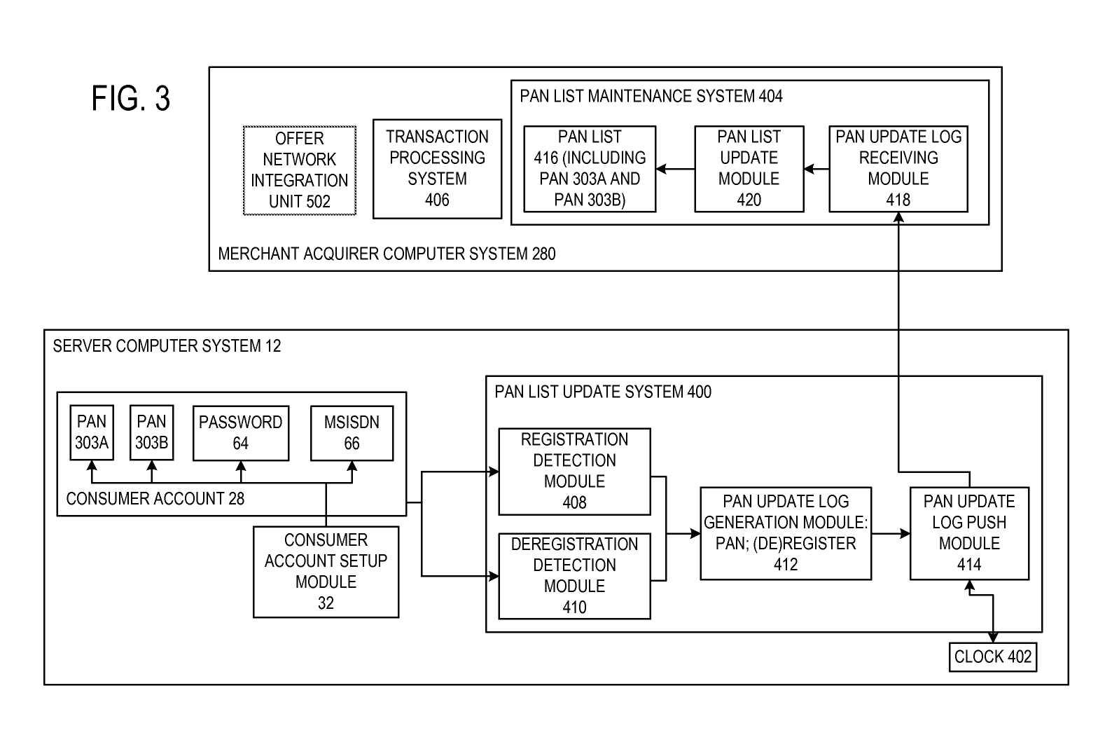

FIG. 3 further shows a PAN list update system 400 and a clock 402 forming part of the server computer system 12. FIG. 3 also shows a PAN list maintenance system 404, a transaction processing system 406 and an offer network integration unit 502 forming part of a merchant acquirer computer system 280.

The PAN list update system 400 includes a registration detection module 408, a deregistration detection module 410, a PAN update log generation module 412, and a PAN update log push module 414.

Both the registration detection module 408 and deregistration detection module 410 are connected to the consumer account 28 and all other consumer accounts to detect when a PAN such as the PAN 303A is added to a consumer account, a second PAN such as the PAN 303B is added to a consumer account, or when a new consumer account is registered with a respective PAN such as the PAN 303A. The PAN update log generation module 412 is connected to the registration detection module 408 and the deregistration detection module 410. Immediately upon detection of a registration or deregistration of a PAN, the PAN update log generation module 412 records both the PAN and a flag to indicate that the PAN is registered or deregistered. Over a period of time, e.g. 60 seconds, a log is generated with a plurality of PANs, wherein each PAN is flagged with a registration or deregistration field.

The PAN update log push module 414 is connected to the PAN update log generation module 412 and the clock 402. The PAN update log push module 414 periodically, e.g. every 60 seconds, retrieves the log generated by the PAN update log generation module 412 and transmits the log over a network interface device of the server computer system 12 to the merchant acquirer computer system 280. The PAN update log push module 414 then clears the log within the PAN list update system 400.

The PAN list maintenance system 404 includes a PAN list 416, a PAN update log receiving module 418, and a PAN list update module 420. The PAN list 416 includes a list of PANs that are known to be registered within the consumer account 28 and other consumer accounts of the server computer system 12. In an alternative embodiment, the PAN list 416 may include all PANs that have in the past been registered with the server computer system 12, wherein each one of the PANs within the PAN list 416 is flagged as being active or not active. For purposes of further discussion, a PAN is considered to be active if it appears within the PAN list 416 and is considered to be not active if it does not appear within the PAN list 416.

The PAN update log receiving module 418 receives the log from the PAN update log push module 414 of the server computer system 12 via a network interface device of the merchant acquirer computer system 280. The PAN list update module 420 then uses the log received with the PAN update log receiving module 418 to update the PAN list 416. PANs that have been flagged as registered within the log are added to the PAN list 416. PANs that have been flagged as deregistered are removed from the PAN list 416.

It can thus be seen that the PAN list 416 includes all PANs that have been registered within the server computer system 12 and no other PANs. The PAN list 416 thus includes both the PANs 303A and B that have been associated with the respective consumer account 28. In another embodiment, the merchant acquirer computer system 280 may receive a list of PANs from another source such as a credit card or issuer computer system.

In the example illustrated in FIG. 3, PANs are used for purposes of consumer account identifiers. In another embodiment, another consumer account identifier, such as a MSISDN, may be pushed to the merchant acquirer computer system 280. The MSISDN can then be used for determining a PAN associated by the MSISDN by the merchant acquirer computer system 280. Alternatively, it may be possible to transmit the MSISDN to an issuer or credit card computer system and the issuer or credit card computer system then determines a PAN associated with a respective MSISDN. In a similar manner, another consumer account identifier, such as an email, social security number etc., can be pushed to any network computer system such as a merchant acquirer, credit card or issuer computer system.

Furthermore, the transaction processing system 406 will use PANs in the transaction flow to identify consumer accounts. In an alternative embodiment, the transaction processing system 406 may use another consumer account identifier such as a MSISDN, email, social security number, etc. in the transaction flow, in which case the PAN list 416 will be replaced by a list of consumer account identifiers of the type used by the transaction processing system 406.

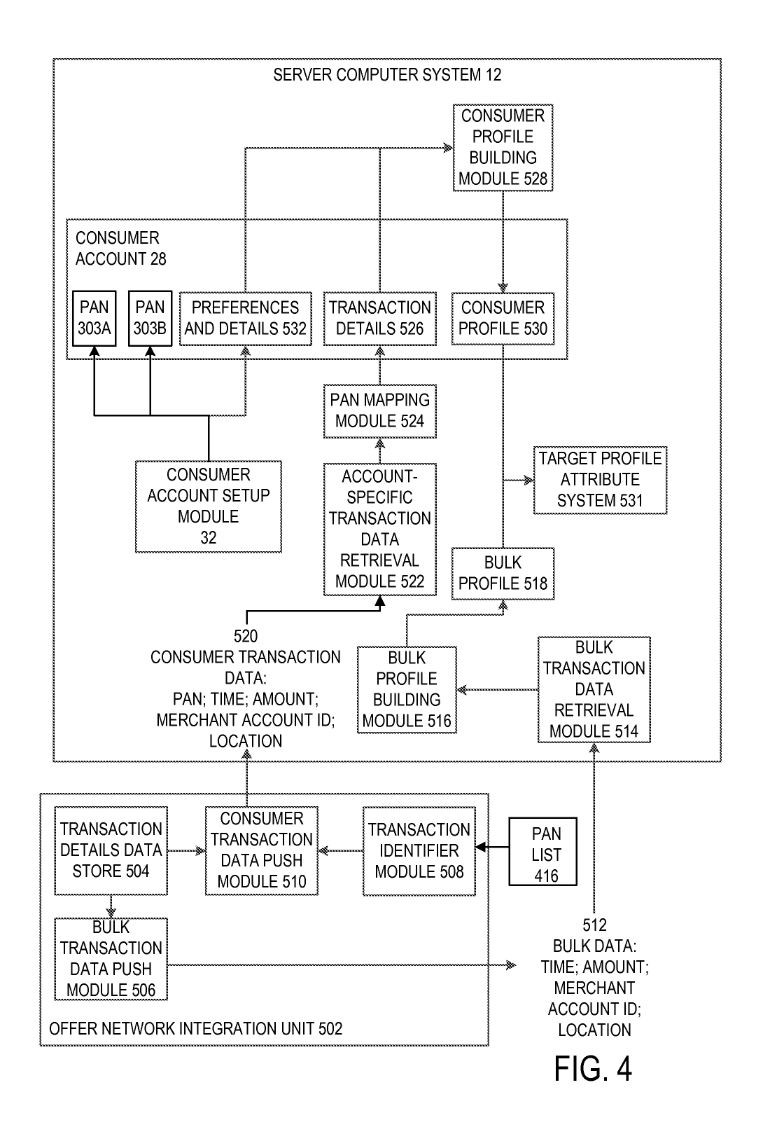

FIG. 4 illustrates further details of the offer network integration unit 502 of the merchant acquirer computer system 280 shown in FIG. 3 and further details of the server computer system 12 as they relate to the transfer of transaction details from the merchant acquirer computer system 280 to the server computer system 12.

The offer network integration unit 502 includes a transaction details data store 504, a bulk transaction data push module 506, a transaction identifier module 508, and a consumer transaction data push module 510. All transactions that are received by the merchant acquirer computer system 280 are stored within the transaction details data store 504. The details of a particular transaction can include the PAN, time, amount, the merchant account ID and location.

The bulk transaction data push module 506 initially transmits details of all the transactions in the transaction details data store 504 to the server computer system 12. The only data that is removed are the PANs that are used for the respective transactions. As such, at 512, the bulk transaction data push module 506 transmits bulk data including the time, amount, merchant account ID and location of each transaction to the server computer system 12.

The server computer system 12 includes a bulk transaction data retrieval module 514, a bulk profile building module 516, and a bulk profile 518. The bulk transaction data retrieval module 514 receives the bulk data 512 from the bulk transaction data push module 506. The bulk profile building module 516 then utilizes the bulk data 512 received by the bulk transaction data retrieval module 514 to build the bulk profile 518. Because the bulk data 512 does not include any PANs, the identities of particular consumers cannot be identified by the server computer system 12 and within the bulk profile 518.

The transaction identifier module 508 is connected to the PAN list 416 and can select particular transactions within the transaction details data store 504 based on the PANs in the PAN list 416. Because the PAN list 416 includes only the PANs 303A and B in the consumer account 28 and other consumer accounts registered within the server computer system 12, the transaction identifier module 508 only identifies transactions within the transaction details data store 504 for PANs within the server computer system 12. The consumer transaction data push module 510 then transmits only the transactions for the PANs identified by the transaction identifier module 508 to be within the PAN list 416 to the server computer system 12. At 520, the consumer transaction data push module 510 thus transmits consumer transaction data including the PAN, time, amount, merchant account ID and location of all transactions within the transaction details data store 504 identified by the transaction identifier module 508 from the PAN list 416.

The server computer system 12 includes an account-specific transaction data retrieval module 522, a PAN mapping module 524, transaction details 526 within the consumer account 28, a consumer profile building module 528, and a consumer profile 530 within the consumer account 28.

The account-specific transaction data retrieval module 522 receives the consumer transaction data 520 from the consumer transaction data push module 510. The PAN mapping module 524 then utilizes the PANs within the consumer transaction data 520 to identify consumer accounts 28 having one or more PANs 303A and B corresponding to the PANs in the consumer transaction data 520. The PAN mapping module 524 then stores all and only the transactions for matching PANs within the transaction details 526. All transactions by a particular consumer are thus stored within the consumer account 28 of the particular consumer.

The consumer can also access the consumer account setup module 32 to enter preferences and details 532 within the particular consumer account 28. Preferences may include particular foods, bars, restaurants, apparel etc. Details may include gender, date of birth, home address, business address etc. The consumer profile building module 528 utilizes all the transaction details 526 and all the preferences and details 532 within the consumer account 28 to build the consumer profile 530 for the particular consumer account 28. The consumer profile 530 thus includes details of time, amount, merchant account ID and location of all transactions corresponding to the PAN 303A or PAN 303B and any other PANs registered within the consumer account 28 and includes the preferences and details 532 of the particular consumer account 28. When the consumer first logs into the account the consumer is automatically asked for details of one bank account so that one PAN is always associated with the respective consumer account 28.

The server computer system 12 further includes a target profile attribute system 531. The target profile attribute system 531 retrieves the bulk profile 518 and the consumer profile 530 of the consumer account 28 and all other consumer profiles of all other consumer accounts 28 registered within the server computer system 12. The target profile attribute system 531 thus includes a corpus of data of all the consumer accounts 28 in the server computer system 12, including all the preferences and details 532, plus all other transactions that went through the merchant acquirer computer system 280 in FIG. 3, but without any consumer-specific preferences and details. The corpus of data forms a representation of transactions by consumers.

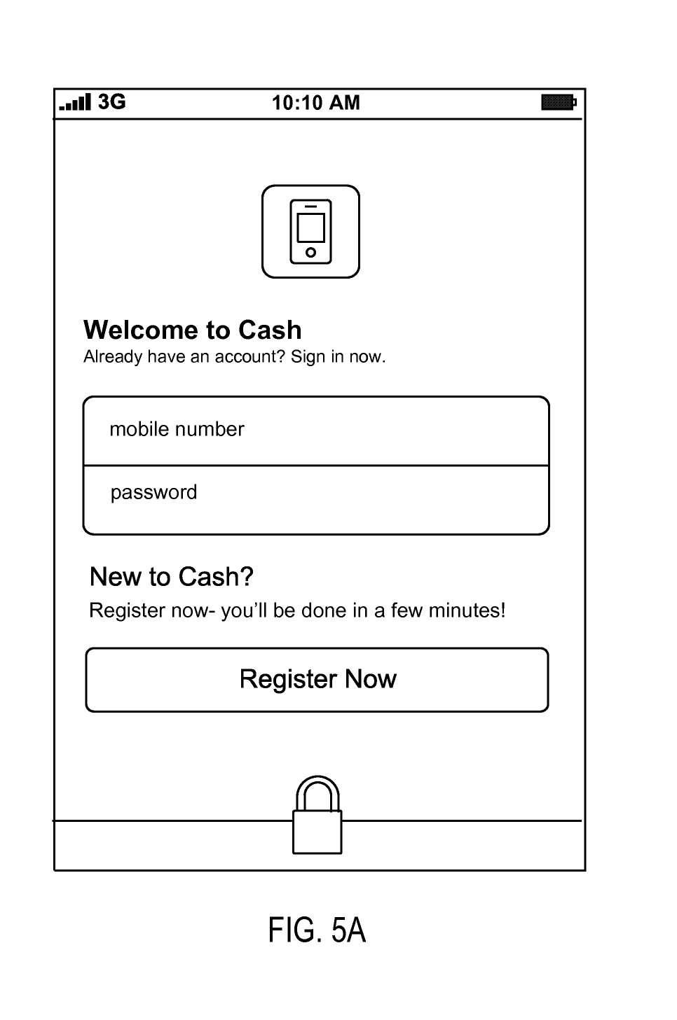

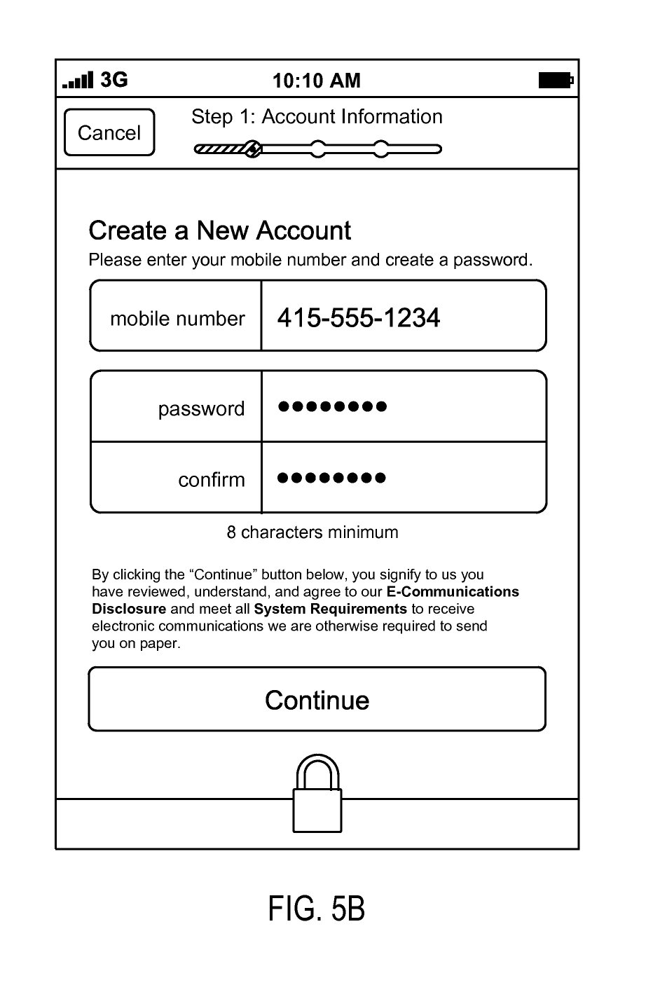

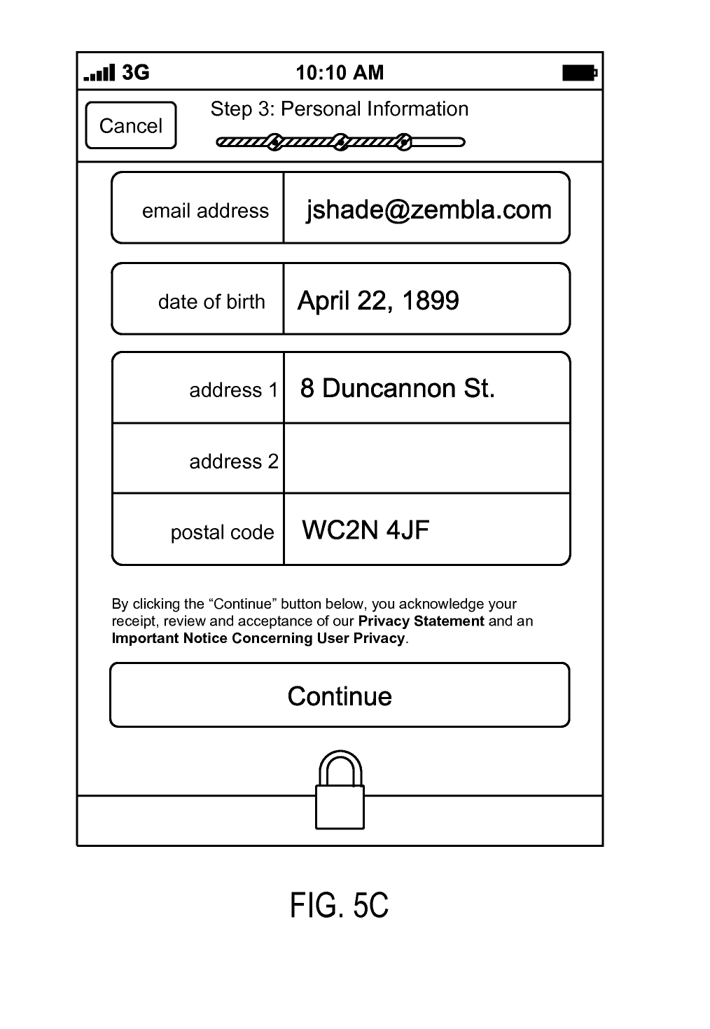

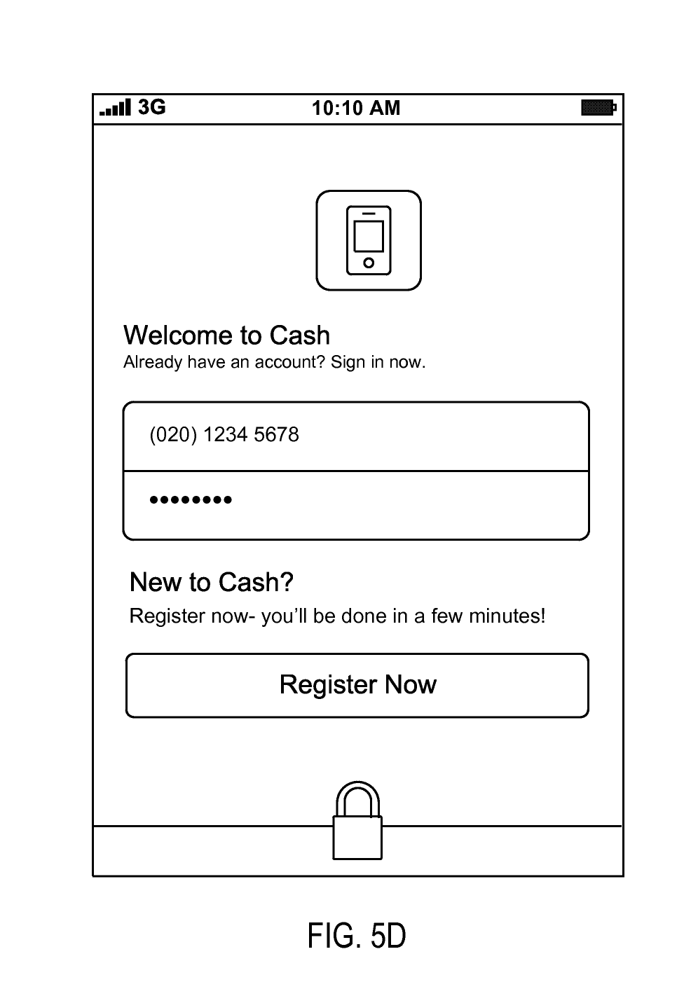

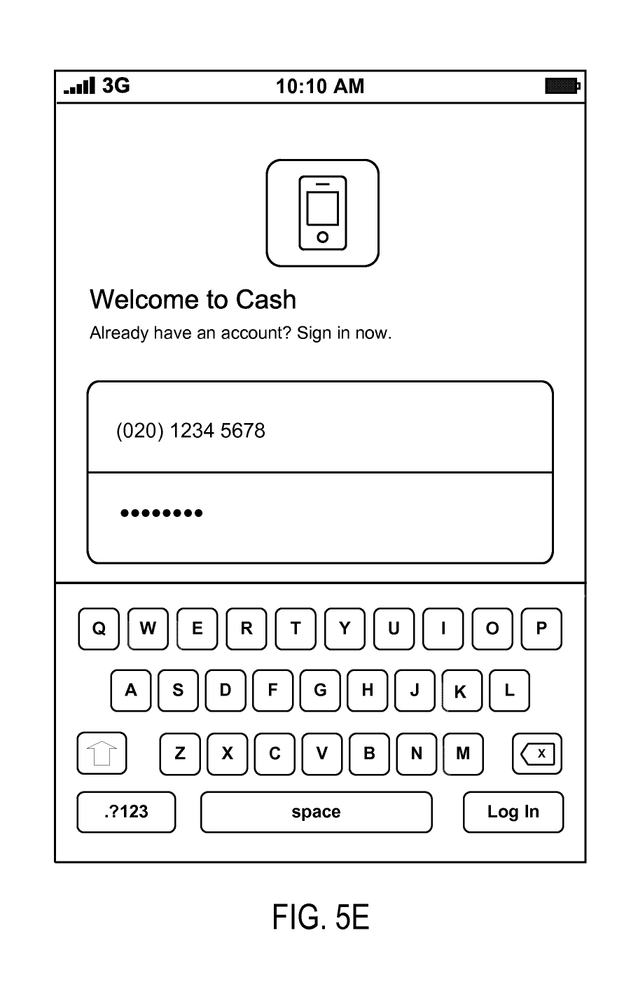

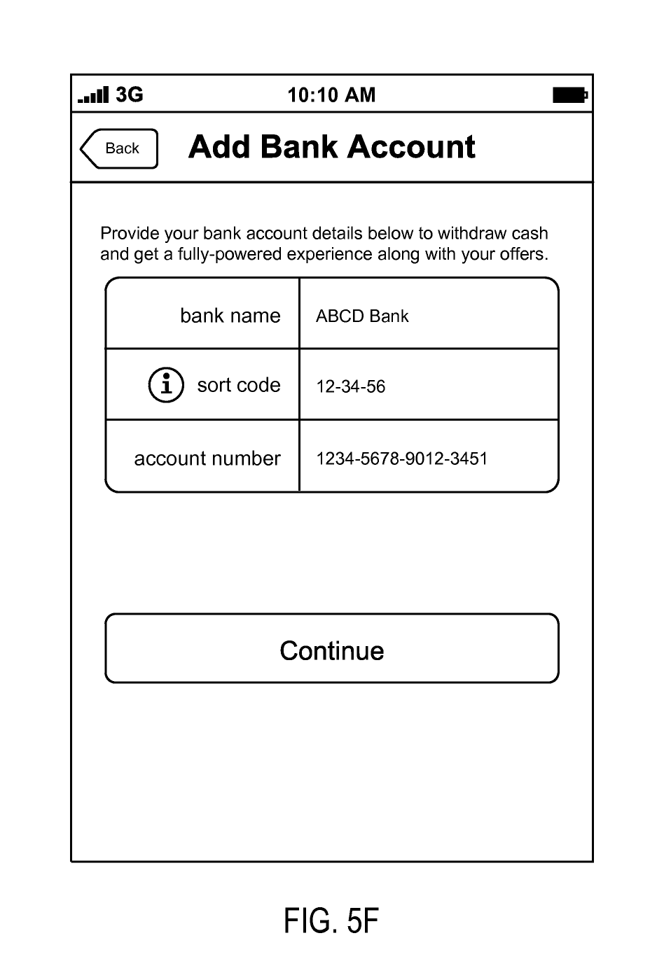

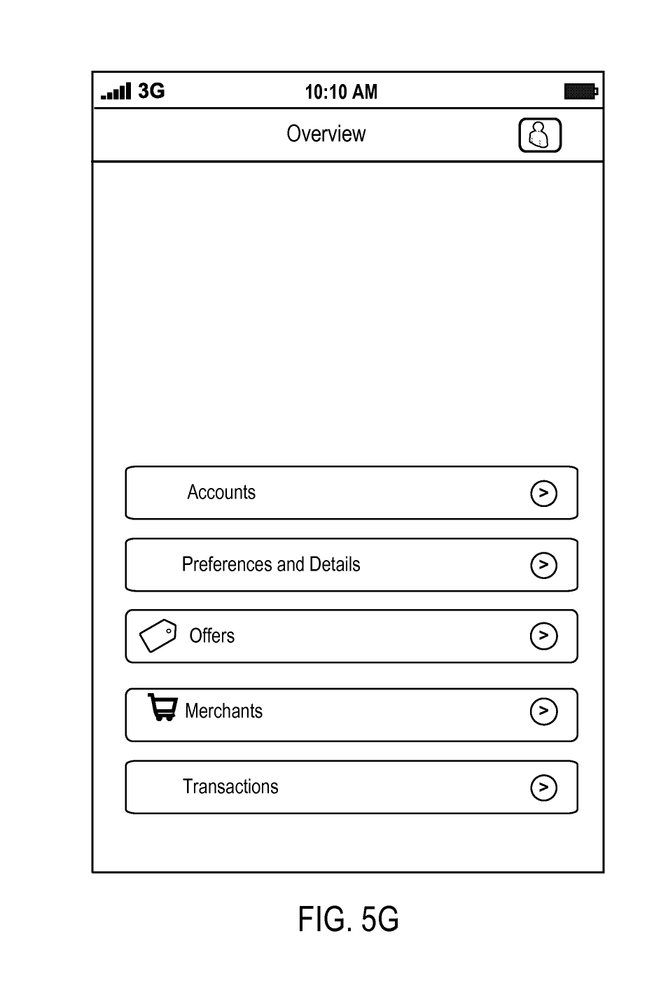

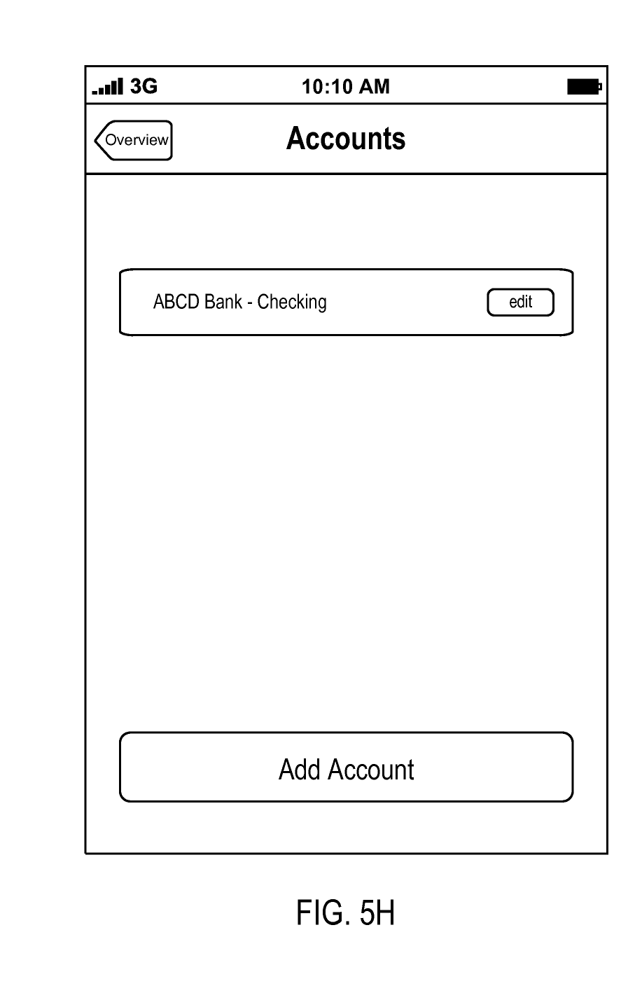

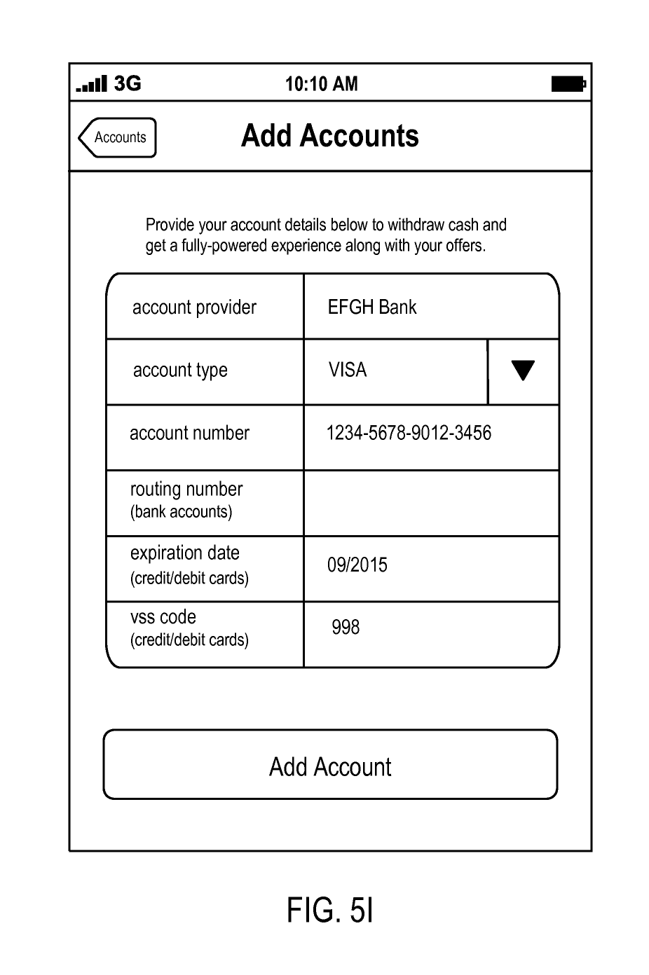

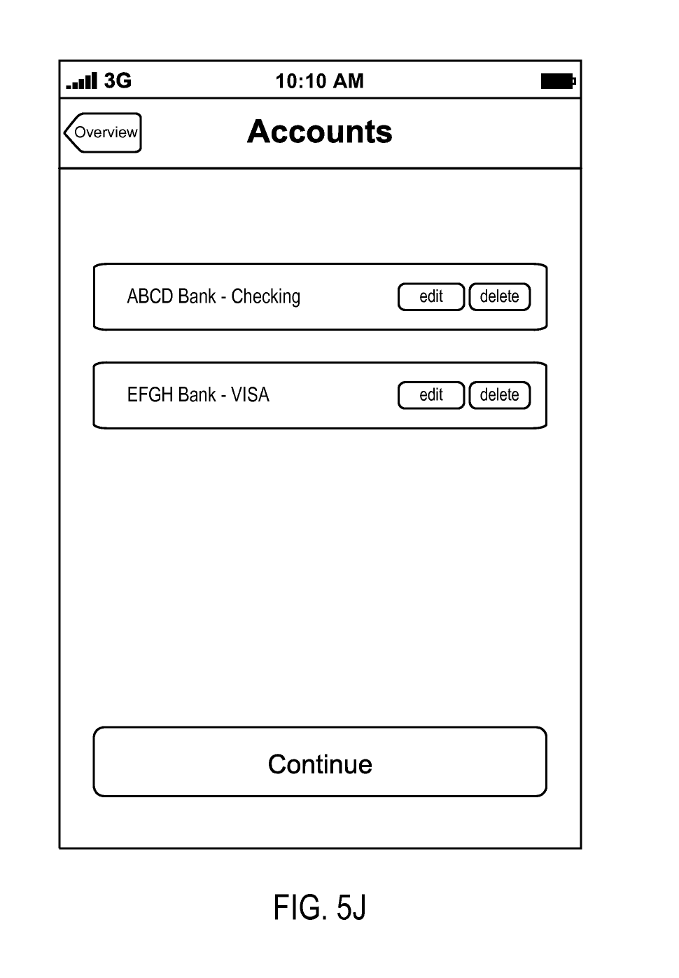

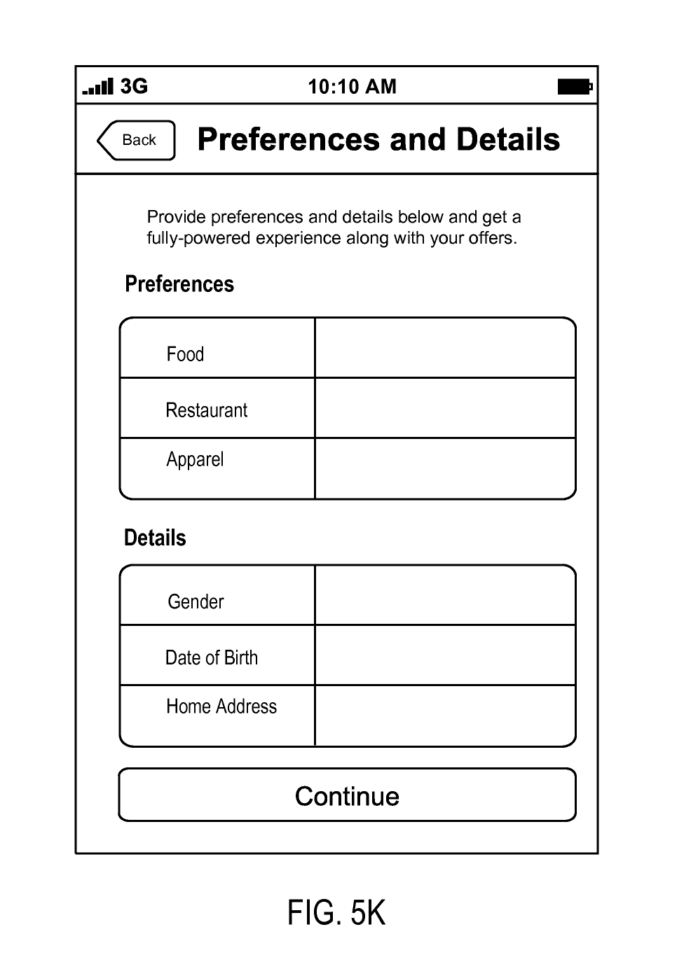

FIG. 5A illustrates a screenshot on the interface 210 in FIG. 2 when the consumer first opens the mobile application 208 and is given an option to either login or create a new account. FIG. 5B is a view similar to FIG. 5A when the consumer first establishes an account using the consumer account setup module 212 in FIG. 2. FIG. 5C is a view similar to FIG. 5B for the consumer to enter further details of the account.

FIGS. 5D and 5E are views that are displayed on the interface 210 in FIG. 2 when the consumer enters the password and the MSISDN in order to log into the respective consumer account 28.

FIG. 5F is a view that allows for the consumer to add a bank account and a PAN (account number) such as the PAN 300 in FIG. 2.

FIG. 5G is a view that is displayed after the consumer has logged into the consumer account 28 and at least one PAN has been stored in the consumer account 28. FIG. 5G includes links for “Accounts,” “Preferences and Details,” “Offers,” “Merchants,” and “Transactions.”

FIG. 5H is a view that is displayed when the consumer selects the link “Accounts” in FIG. 5G. The bank account that has been added by the consumer during the first login is displayed. The consumer is permitted to edit details of the bank account. However, because only details of one bank account are stored, the consumer is not permitted to delete the bank account and its details. The view of FIG. 5H also includes a button for adding another account.

FIG. 5I illustrates a view that is displayed after the consumer selects the “Add Account” button in FIG. 5H. The consumer can add details of another bank account, including another 16 digit PAN such as the PAN 300B in FIG. 2. FIG. 5I also includes a link to allow the consumer to add a further account. An “Accounts” button takes the interface 210 to the view of FIG. 5H. FIG. 5J is the same as the view of FIG. 5H, except that the second bank account has been added. Both bank accounts now have a “Delete” button that permit the consumer to delete either bank account. The consumer can only delete one bank account if there are at least two bank accounts. The “Delete” button is removed if there is only one bank account remaining. Both FIGS. 5H and 5J include an “Overview” button that returns the interface 210 to the view in FIG. 5G.

FIG. 5K is a view that allows the consumer to enter preferences and details as hereinbefore described.

### 3). Merchant Offers

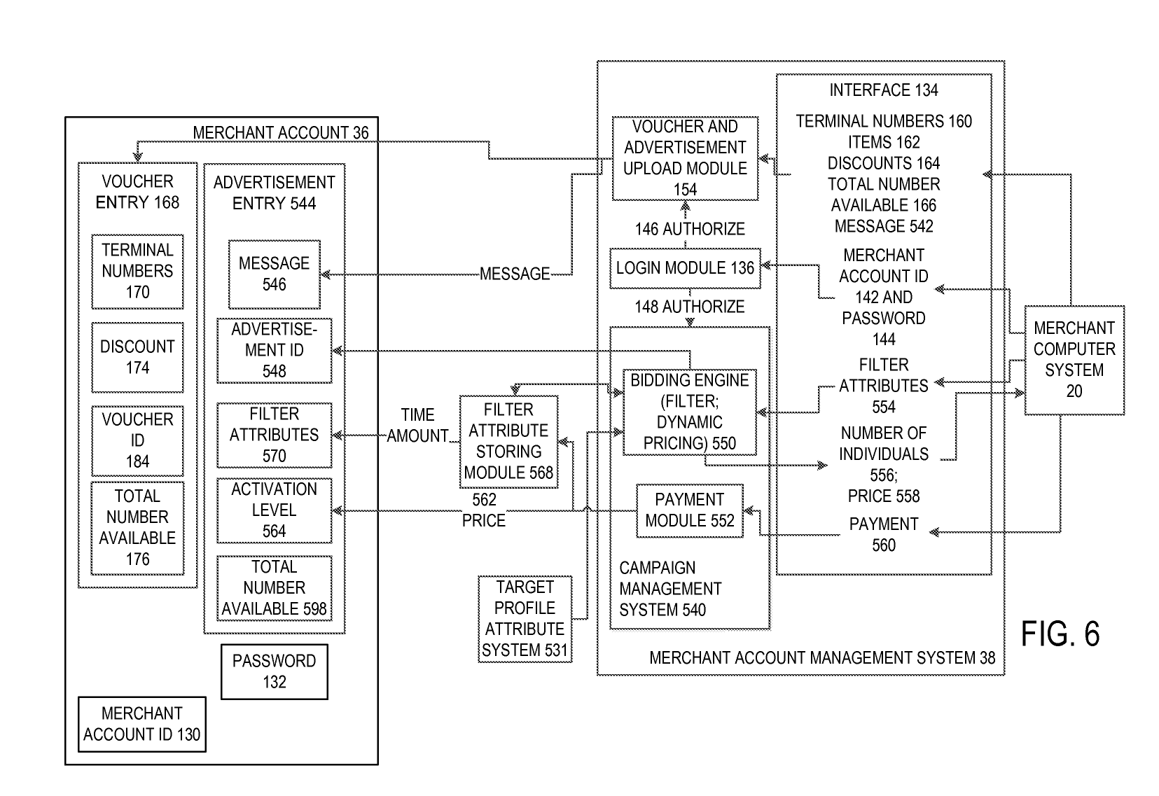

As shown in FIG. 6, the merchant account 36 in FIG. 1 is established by assigning a merchant account identifier (ID) 130 and a password 132. Each merchant account 36 will thus have a different merchant account ID 130.

The merchant account management system 38 includes an interface 134, a login module 136, a voucher and advertisement upload module 154, and a campaign management system 540.

A merchant at the merchant computer system 20 can log into the merchant account 36 by downloading the interface 134 and entering a merchant account ID 142 and a password 144 via the interface 134 into the merchant account management system 38. The login module 136 then compares the merchant account ID 142 and the password 144 with the merchant account ID 130 and password 132 to identify and provide access to the respective merchant account 36. The login module 136 then at 146 authorizes access to the voucher and advertisement upload module 154 by the merchant computer system 20 only for purposes of the respective merchant account 36 having the merchant account ID 130 matching the merchant account ID 142. At 148, the login module 136 similarly authorizes access to the campaign management system 540 by the merchant computer system 20.

A merchant at the merchant computer system 20 uses the interface 134 to enter voucher information, including terminal numbers 160, items 162, discounts 164, the total number available 166 and a message 542. The voucher and advertisement upload module 154 then stores a respective voucher entry 168 or advertisement entry 544 in or associated with the merchant account 36 having the merchant account ID 130.

The voucher entry 168 includes terminal numbers 170 corresponding to the terminal numbers 160, a discount 174 corresponding to one of the discounts 164, and a total number available 176 corresponding to the total number available 166. By way of example, the terminal numbers 170 may be terminals 2 and 5, the discount 174 may be 50 cents and the total number available 176 may be 60. Similarly, additional voucher entries can be entered from the merchant computer system 20 through the interface 134 and the voucher and advertisement upload module 154. Each voucher entry has a respective data set for terminal numbers 170, a discount 174 and the total number available 176. Each voucher entry also has a respective voucher ID 184.

The advertisement entry 544 includes a message 546 that is the same as the message 542 entered into the interface 134. Similarly, additional advertisement entries can be entered from the merchant computer system 20 through the interface 134 and the voucher and advertisement upload module 154. Each advertisement entry has a respective message similar to the message 546, but the messages are all different. Each advertisement entry also has a respective advertisement ID 548.

The campaign management system 540 includes a bidding engine 550 with a filter and a dynamic pricing capabilities and a payment module 552. The bidding engine 550 receives the data from the target profile attribute system 531 and is accessible from the merchant computer system 20 through the interface 134. A merchant at the merchant computer system 20 enters filter attributes 554 through the interface 134 into the bidding engine 550. One filter attribute may for example be spend amount. In such an example, the merchant may select spend amount's of between $10 and $15. The filter of the bidding engine 550 then identifies which transactions within the target profile attribute system 531 will fall within the range of $10 to $15. If a transaction is for example $12, then the transaction would be identified as being potentially relevant for the particular merchant. As previously mentioned, the time of each transaction is also recorded within the target profile attribute system 531. The merchant can select a time range e.g. from 11 am until 1 pm and/or select frequency e.g. at least every day or at least once a week, whereafter the filter of the bidding engine 550 identifies particular consumers that have spending habits within the time-specific filter attribute specified by the merchant. The merchant can also select a filter attribute that corresponds to location. For example, the merchant can specify a particular address, namely street and number and specify a radius around the particular address. Alternatively, the merchant can specify a particular neighborhood. The filter of the bidding engine 550 then identifies transactions that occur at locations within the radius or neighborhood specified by the merchant. Other filter attributes that can be specified by the merchant include for example gender (e.g. male) or age (e.g. between 24 and 36 years old).

The pricing capabilities of the bidding engine 550 then calculates a price based on the filter attributes 554. The price is determined by comparing bids from other merchant computer systems for the same filter attributes 554 or overlapping filter attributes. An overlap may for example exist if one merchant bids for a price range of $7 to $12 and another merchant bids for a price range of $10 to $15. The bidding engine 550 then transmits a number of individuals 556 and a price 558 to the merchant computer system 20 for display within the interface 134 at the merchant computer system 20. Alternatively, the bidding engine 550 can calculate and transmit a number of different prices, wherein a high price will receive a more favorable placement or preferential transmission by a decision engine. Alternatively, the bidding engine 550 does not calculate a price but the price is instead entered by the merchant computer system 20 as part of a bid.

The merchant at the merchant computer system 20 transmits a payment instruction with a payment 560 through the interface 134 to the payment module 552. In the present example, the payment module 552 enters a price 562 as an activation level 564 within the advertisement entry 544. The price 562 may be either a price calculated by the pricing capabilities of the bidding engine 550 or may be the bidding price as entered by the merchant at the merchant computer system 20.

The server computer system also includes a filter attribute storing module 568 that is connected to the bidding engine 550 and the payment module 552. The filter attribute storing module 568 has functionality that is activated by the payment module 552 when the payment 560 is received by the payment module 552. The filter attribute storing module 568 responds to the payment module 552 by extracting the filter attributes 554 from the bidding engine 550 and storing the filter attributes 554 as filter attributes 570 within the advertisement entry 544. A separate module also receives the total number available from the bidding engine 550 based on the filter attributes 554 and the payment 560 and stores the total number available as the total number available 598 within the advertisement entry 544.

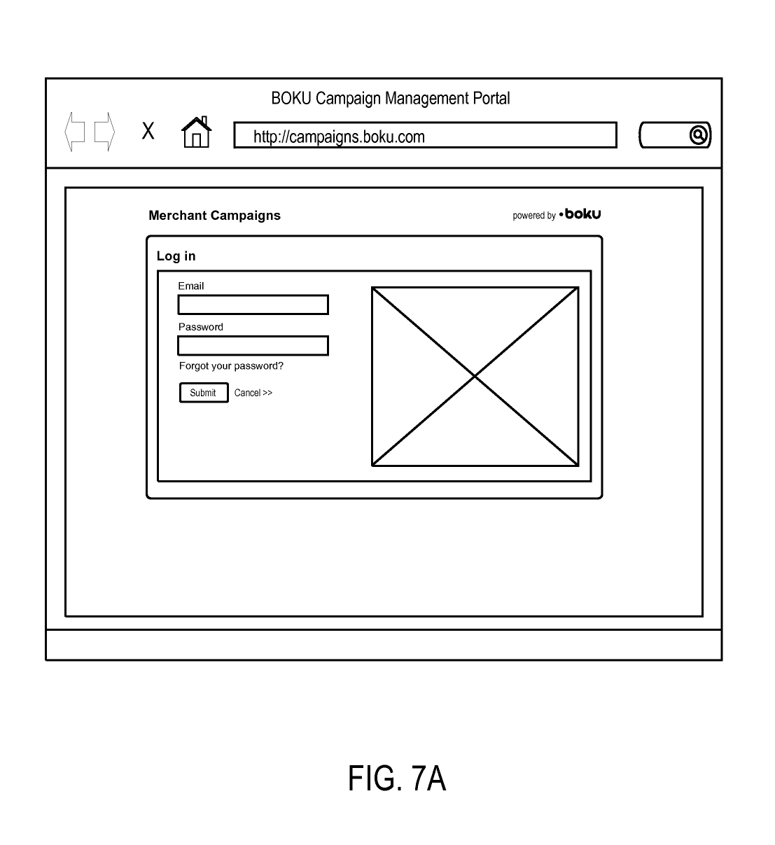

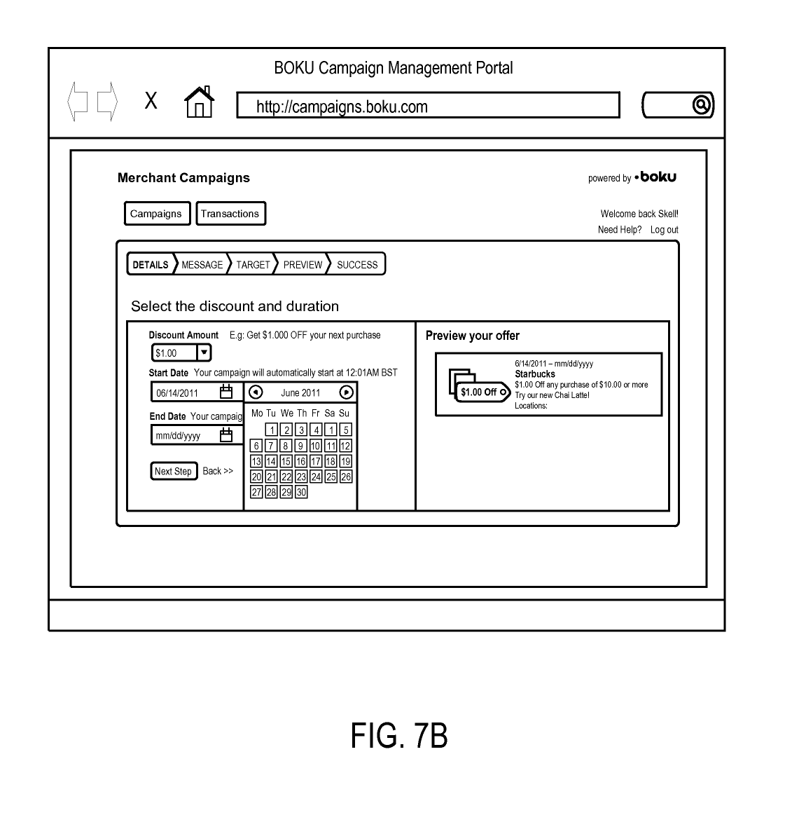

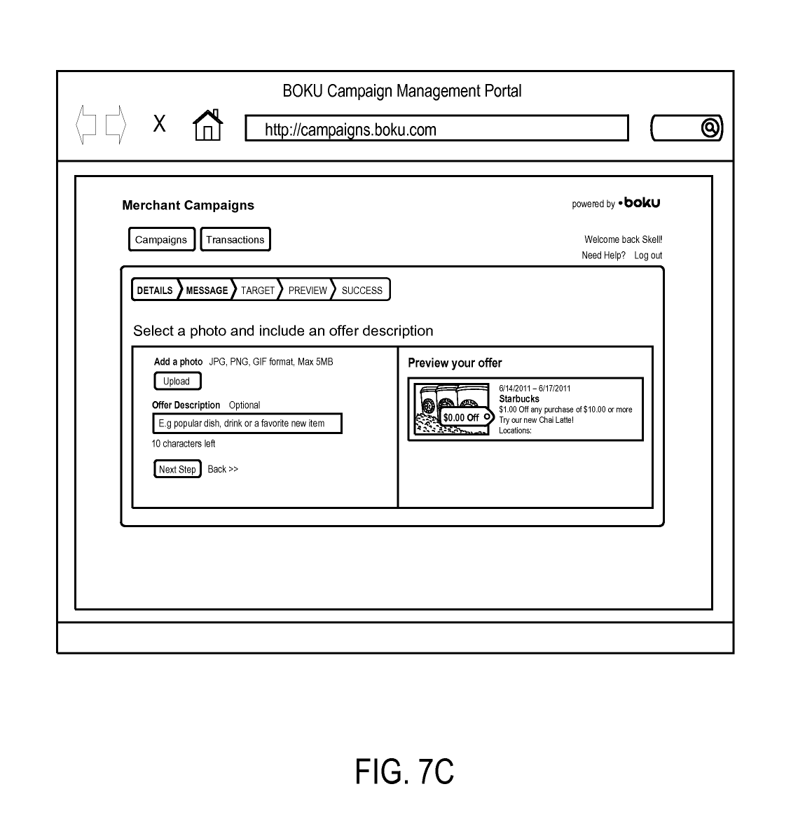

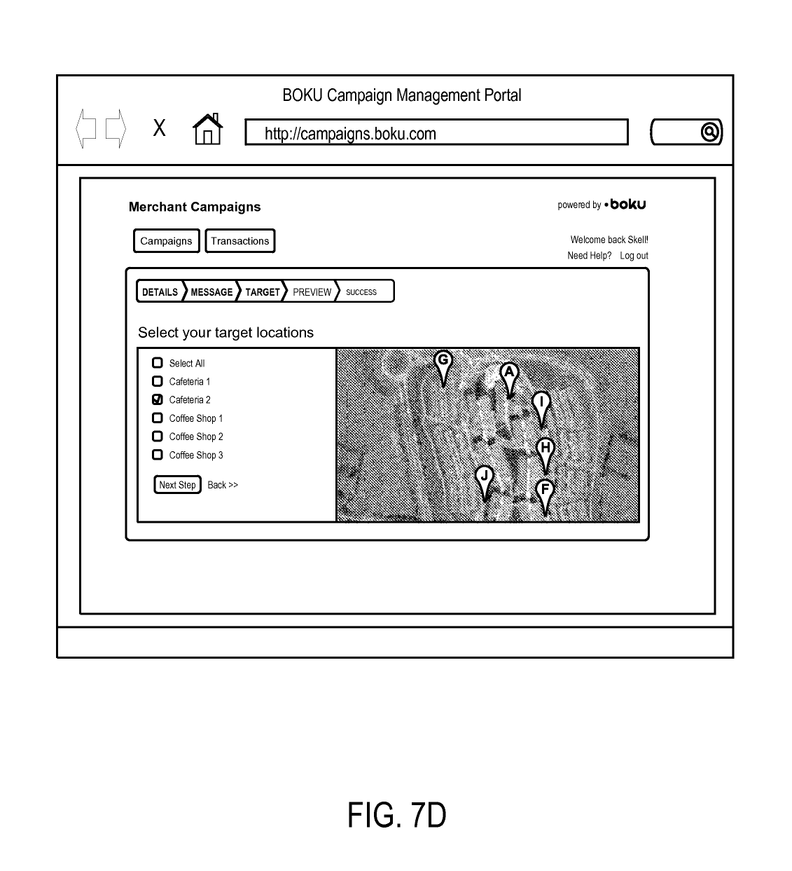

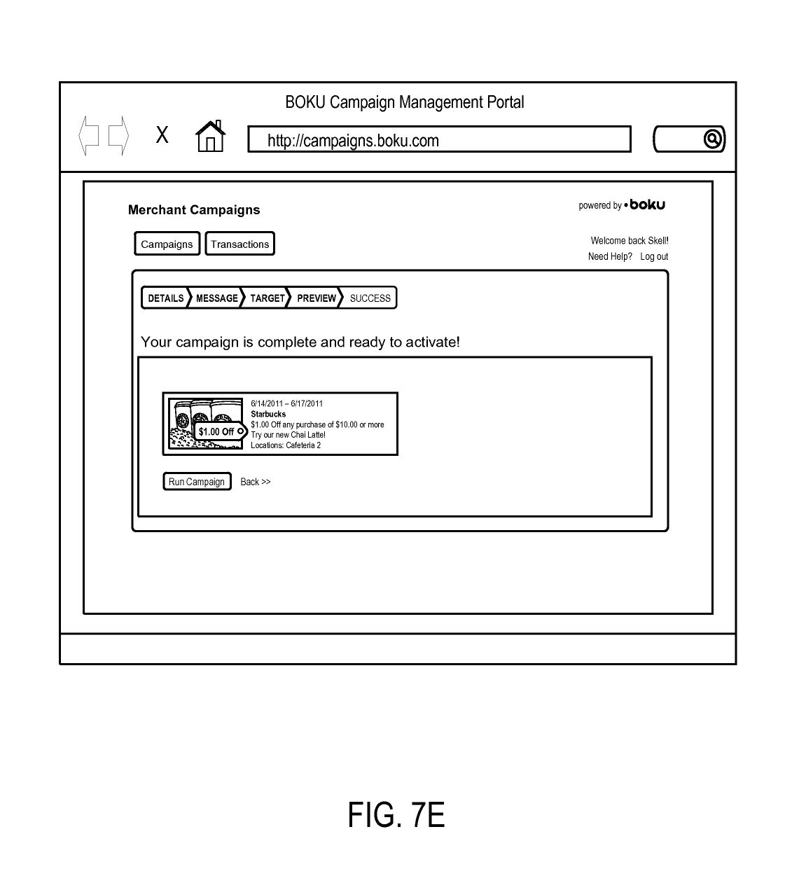

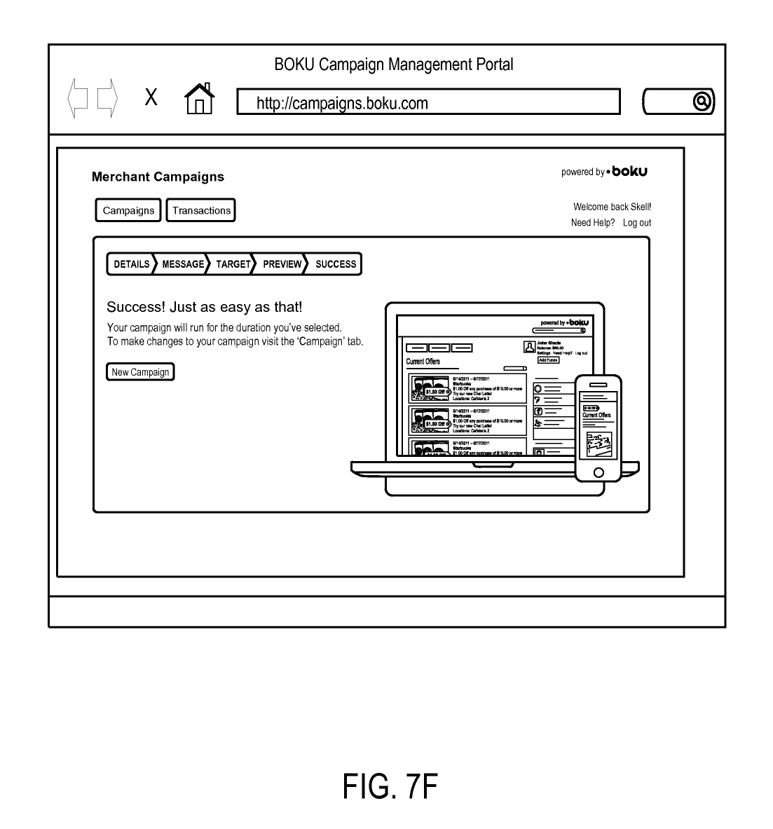

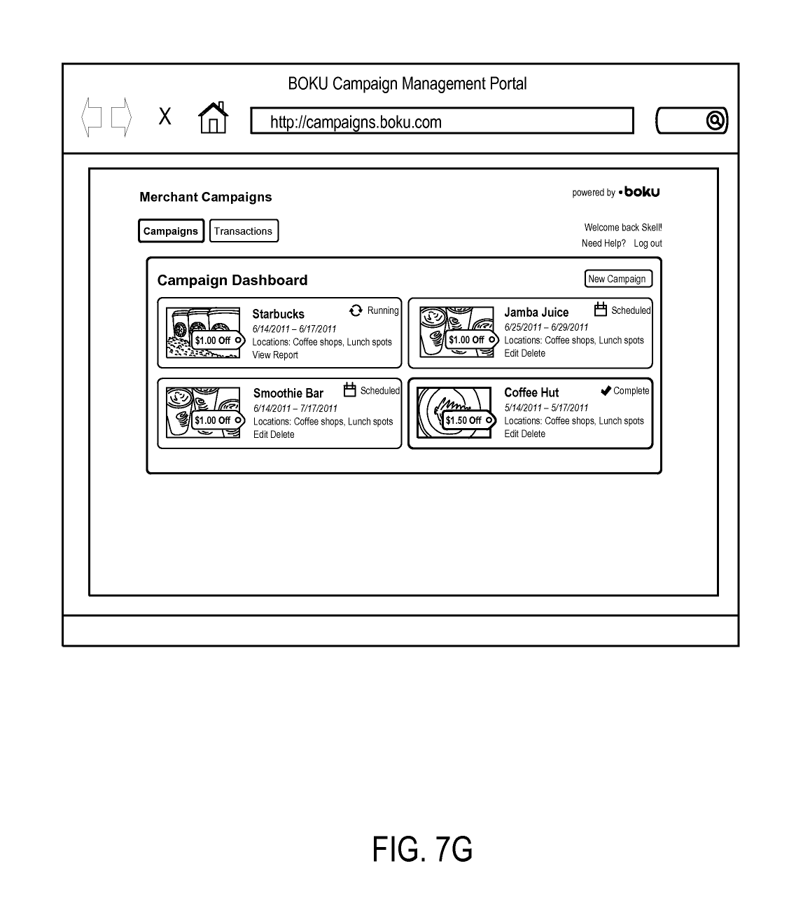

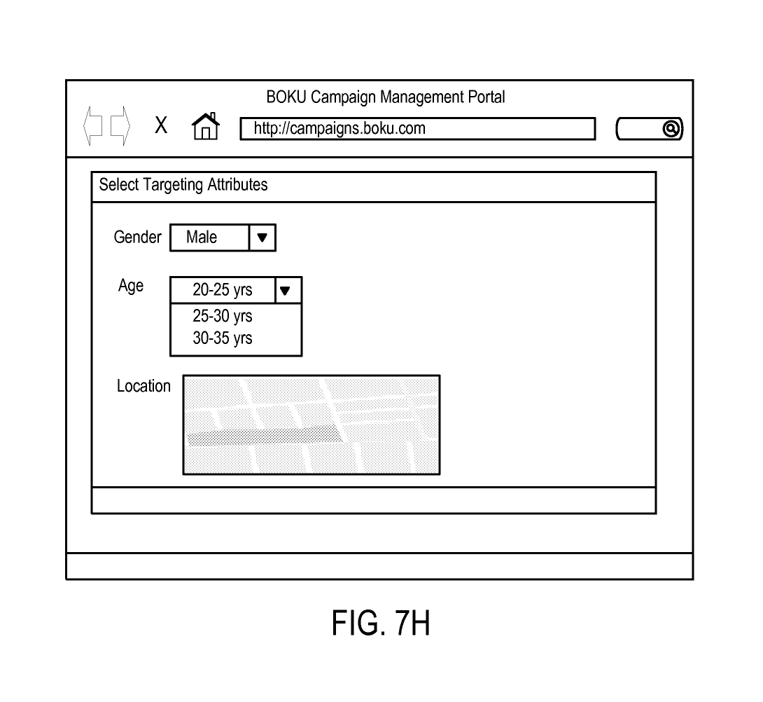

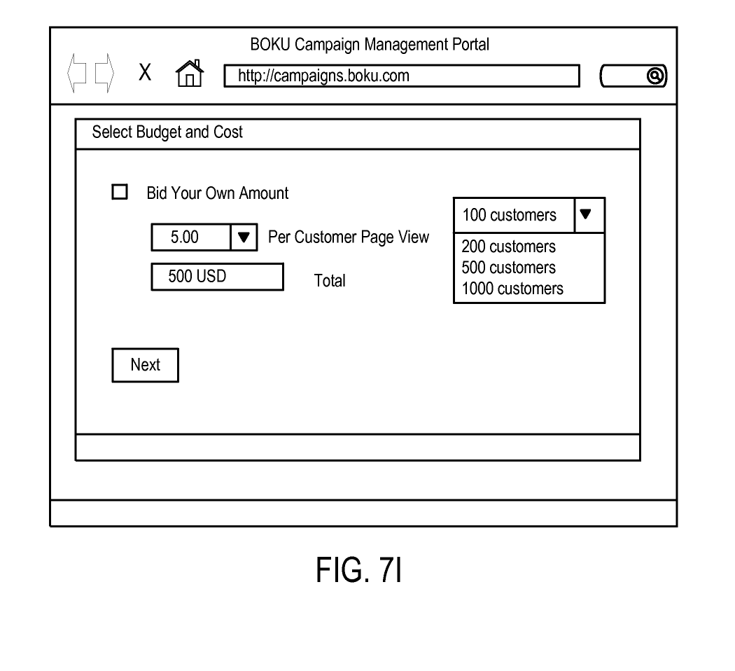

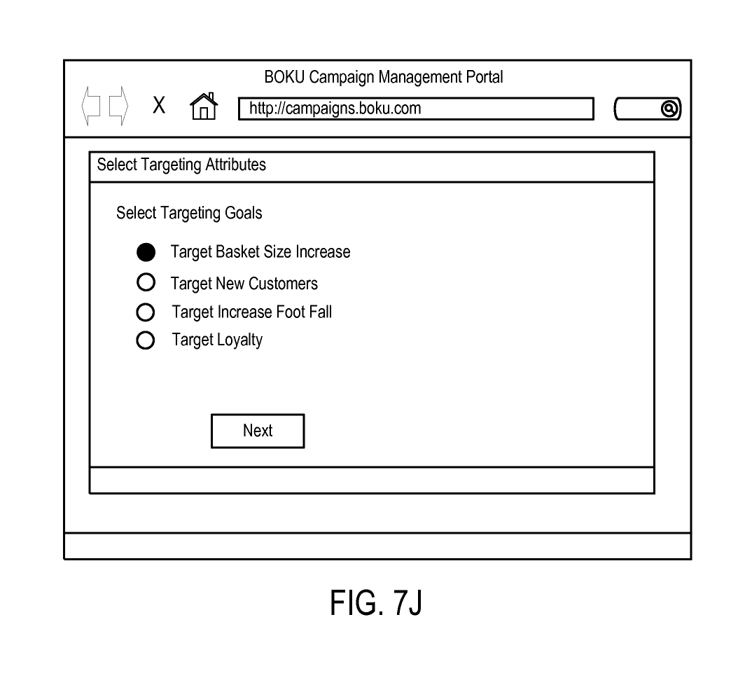

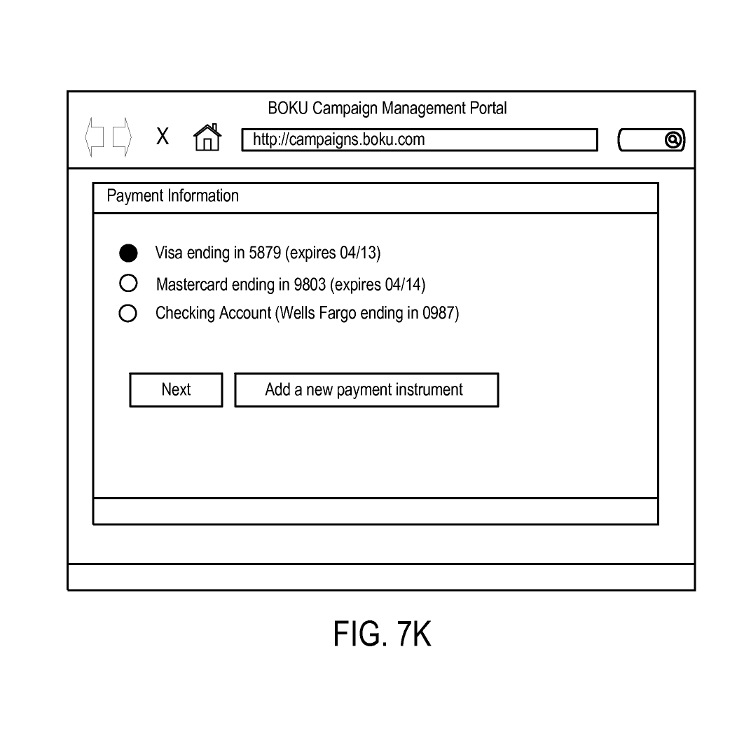

FIG. 7A illustrates a screenshot that appears in the interface 134 when viewed within a browser window of a browser application at the merchant computer system 20 in FIG. 6. The merchant logs in using an email and a password.

FIG. 7B illustrates a screenshot that is displayed at the merchant computer system 20 after login and when a merchant begins to enter details of an offer. The interface 134 allows for entry of a discount (“Discount Amount”) and start and end dates of the offer. A preview of the offer is also displayed.

In FIG. 7C the merchant is given an opportunity to upload a photo or other image of the offer. The photo or image will then be displayed within the respective voucher entry, e.g. the voucher entry 168 in FIG. 6. The photo or image can be uploaded from the merchant computer system 20 or from another location on a network.

In FIG. 7D the merchant is given an opportunity to restrict the offer to certain locations, while excluding other locations.

In FIG. 7E the merchant is given an opportunity to preview the offer as it will appear before approving the offer. The merchant then selects a button “Run Campaign” to approve the offer.

FIG. 7F is a screenshot displaying to the merchant that the offer is successful. The consumer can then select a button “Campaigns.”

FIG. 7G illustrates a screenshot that is subsequently displayed to the merchant, illustrating the offer that has just been approved by the merchant and all other offers that are scheduled, completed or presently running based on the respective merchant account having the merchant account ID 130 in FIG. 6.

FIG. 7H illustrates a screenshot that is displayed for the merchant to enter the filter attributes 554 if FIG. 6. In the present example, the merchant can select the gender, an age bracket and a location. The location can be selected in one of many manners. In the given example, the merchant can select an area on a map. In another example, the merchant can enter an address and a radius. In a further example, the merchant can enter the name of a neighborhood.

In FIG. 7I, the merchant selects a bid price. In the given example, the check box “Bid Your Own Amount” is not checked. Instead, a price per customer page view is calculated by the bidding engine 550 in FIG. 6 and the merchant selects a number of customers that should be targeted. In the present example, the price per customer view is $5 and the merchant selects 100 customers, thereby bringing the total to $500 USD. Alternatively, the merchant can select the box “Bid Your Own Amount” and manually enter an amount. In such an example, a subsequent screen will be displayed to the merchant showing the merchant how many customers will be targeted for the amount that the merchant has bid and/or where the advertisement will be placed in numerical order. The merchant can then select to increase or decrease the amount with a corresponding increase or decrease in the number of customers or the placement of the advertisement.

In FIG. 7J, the merchant can select specific targeting goals. The first targeting selection that can be made by the consumer is to target a basket size increase. The merchant may for example select consumers who routinely spend less than $10 for purposes of increasing the spend amount of such consumers to, for example at least $15. In such a scenario, the merchant may for example enter $15 as the amount above which the consumer will receive a discount and the server computer system 12 will have a module that extracts consumers that routinely spend less than $15, for example more than $3 less than $15 or less than 90% of $15.

The second targeting selection that can be made by the merchant is to target new customers. The server computer system 12 then only extracts consumers that have been registered with the server computer system 12 within the last week, two weeks or the like.

The third targeting selection that can be made by the merchant is to increase “footfall” for purposes of increasing traffic during slow hours. In such a scenario, the merchant may for example indicate that the merchant wishes to increase “footfall” between 1 pm and 3 pm. The server computer system 12 has a module that looks for consumers that routinely spend for similar items at the same or other stores outside of the time window specified by the merchant, for example at 10 am.

The fourth targeting option that is selectable by the merchant is to target loyalty. In such a scenario, the server computer system will look for consumers who have in the past made purchases at the particular merchant, but have not made any purchases for more than a predetermined amount of time such as two weeks. The server computer system will then automatically increase the number of push notifications to such consumers as opposed to other consumers.

In FIG. 7K the merchant selects a payment method that has previously been stored in association with the respective merchant account. The payment method forms part of the payment instruction that is received by the payment module 552 in FIG. 6.

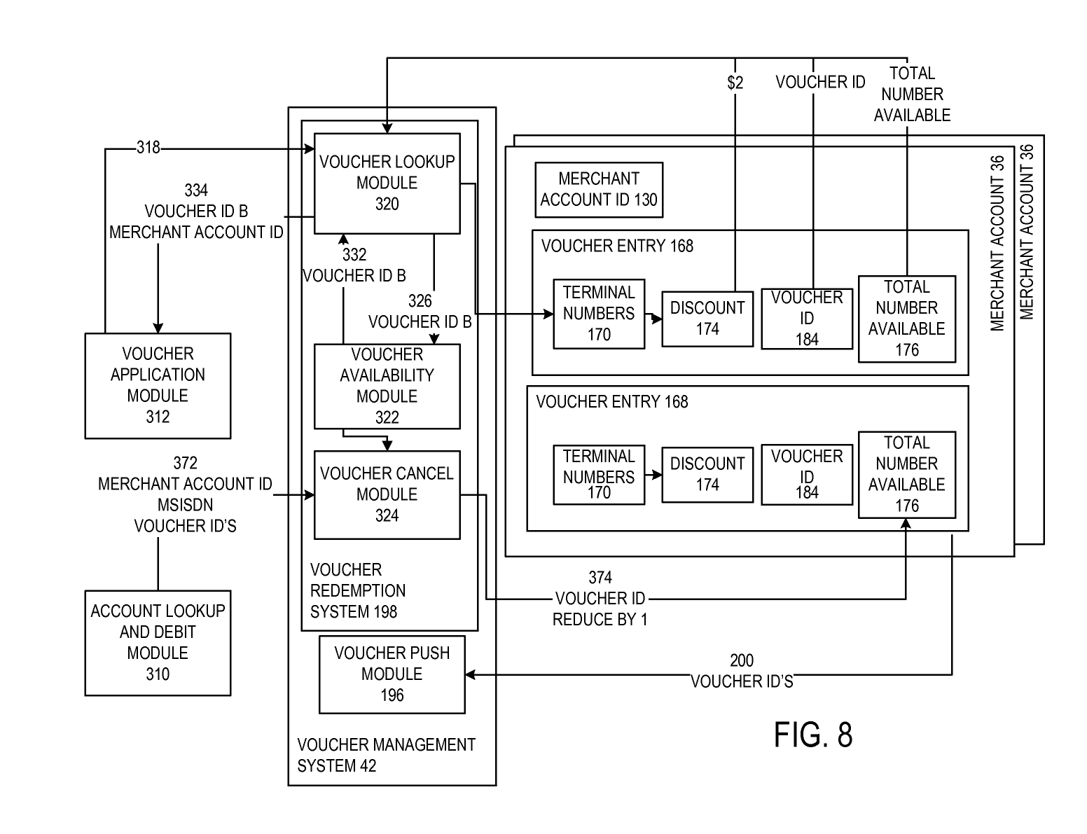

As shown in FIG. 8, the voucher management system 42 includes a voucher push module 196 and a voucher redemption system 198.

The voucher push module 196 at 200 receives all the voucher ID's 184 of the voucher entries. Referring again to FIG. 2, the voucher push module 196 at 202 then enters the voucher ID's 184 as voucher ID's 204 in the consumer account 28 and all other consumer accounts that have been targeted by a merchant. As such, merchant offers in the form of voucher ID's are associated with one of the consumer accounts 28 having a MSISDN 66 as a consumer account ID.

The merchant offers in the form of the voucher ID's 204 can then be further processed based on the association of the voucher ID's 204 with the MSISDN 66 of the respective consumer account 28. In particular, the voucher ID's 204 can be transmitted to the mobile device 24 and be received by a mobile application that has been logged into the respective consumer account 28 by way of an identifier of the consumer account 28 having the MSISDN 66 as a consumer account identifier. Following login of the mobile application 208 into the consumer account 28, the vouchers viewing module 216 is accessible by a consumer operating the mobile device 24. The consumer then directs the vouchers viewing module 216 to download the voucher ID's 204 from the consumer account 28 as voucher ID's 260 received by the vouchers viewing module 216. Each voucher ID 260 has an associated image and the images are collectively displayed as voucher images 262 within the interface 210. Each voucher entry 168 within the merchant account 36 of FIG. 6 may for example have a respective voucher image and the voucher images are separately downloaded by the vouchers viewing module 216 of FIG. 2 based on the voucher ID's 260. What is important to note however, is that the voucher ID's 260 and the voucher images 262 are transmitted by the server computer system 12 in FIG. 1 and are received by the mobile device 24 based on a matching of the MSISDN transmitted by the mobile application 208 during login and the MSISDN 66 of the respective consumer account 28.

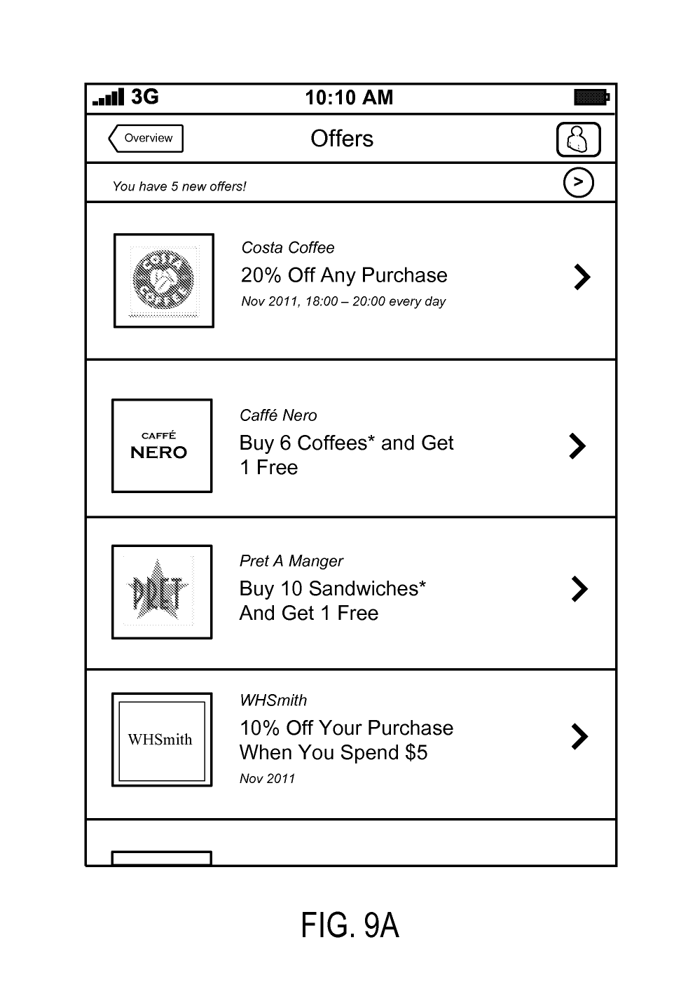

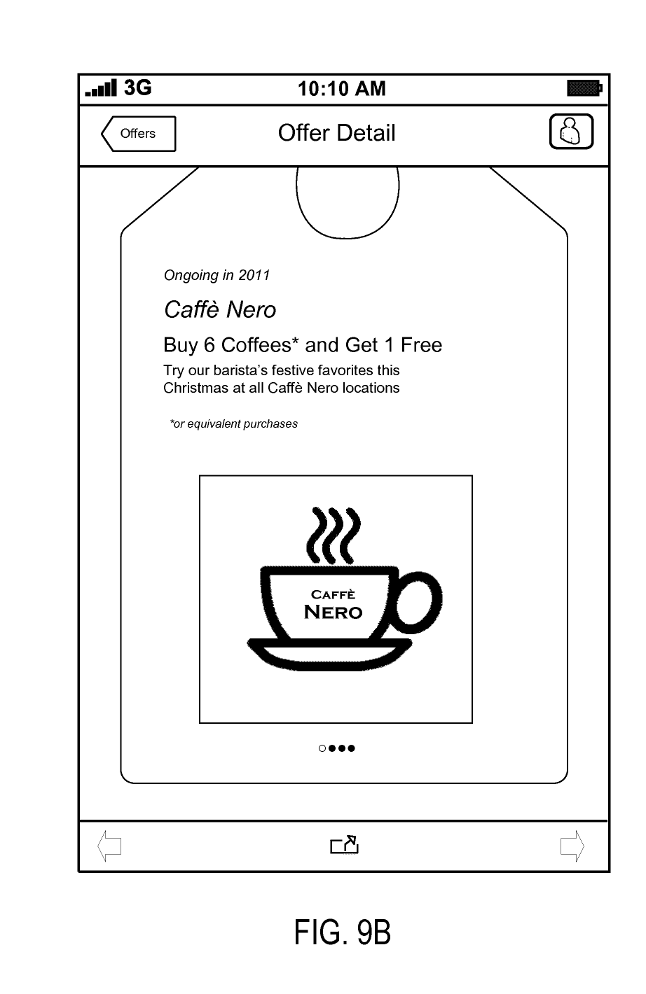

FIG. 9A illustrates a plurality of voucher images such as the voucher images 262 in FIG. 2 that are displayed after the consumer selects “Offer” in FIG. 5G. The consumer can select any one of the vouchers to obtain more information about the voucher and the offer.

FIG. 9B is a view that is displayed showing more information about one of the vouchers.

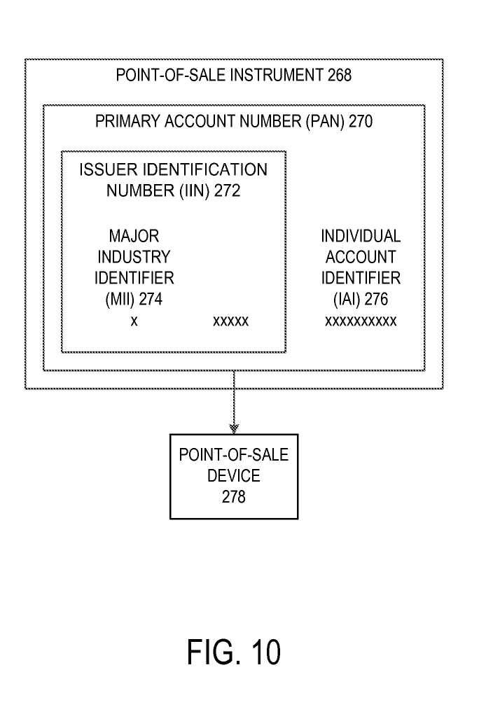

Referring to FIG. 10, the consumer uses a single point-of-sale instrument 268 to pay for an item that the consumer wishes to purchase. The point-of-sale instrument 268 may for example be a credit card, a bank card or a Near Field Communication (NFC) device. The point-of-sale instrument 268 includes a single 16 digit primary account number (PAN) 270. The first six digits of the PAN 270 are an issuer identification number (IIN) 272. The first digit of the IIN 272 is a major industry identifier (MII) 274. The last ten digits of the PAN 270 comprise an individual account identifier (IAI) 276.

### 4). Transaction Processing

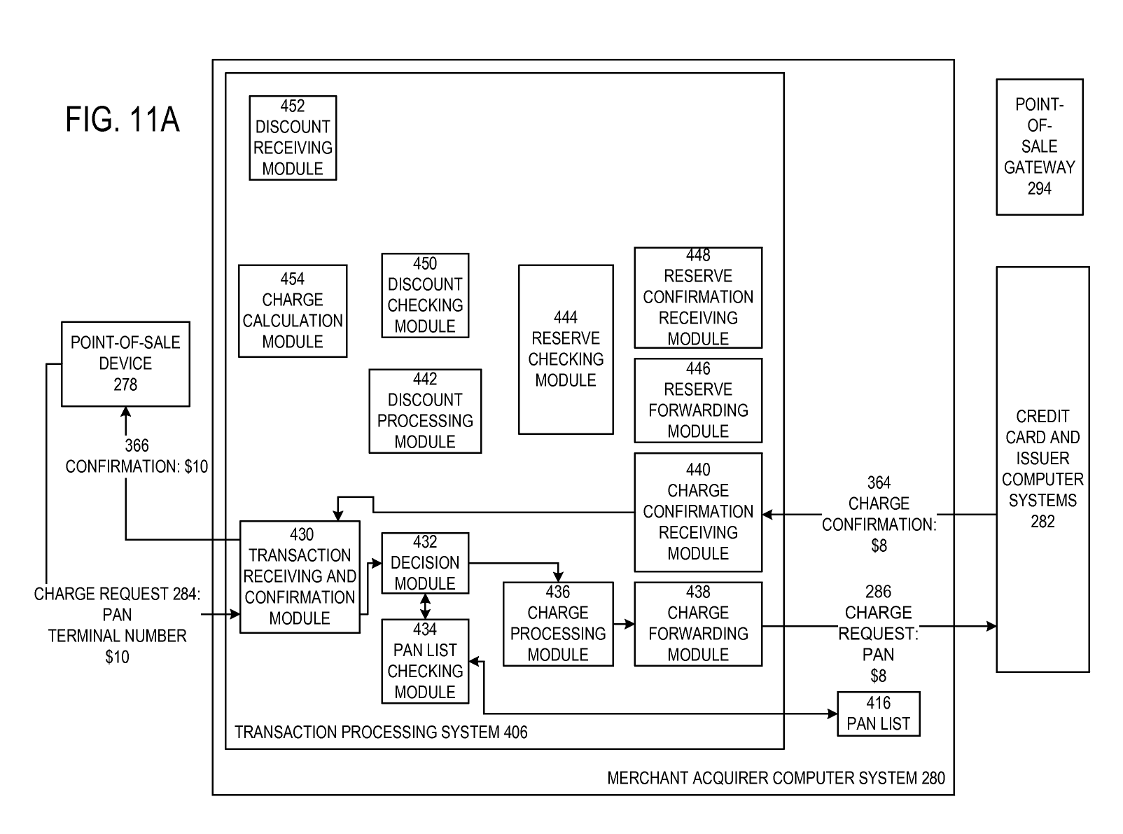

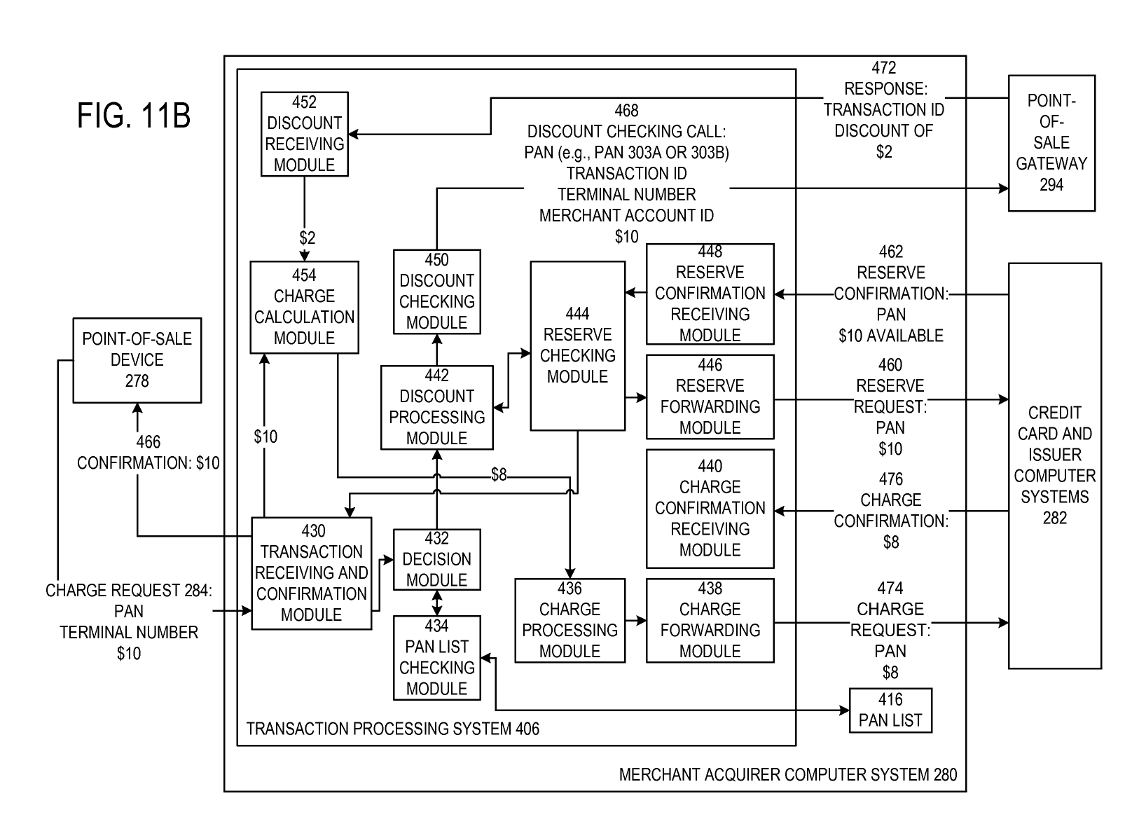

As shown in FIG. 11A, the point-of-sale network 26 includes a point-of-sale device 278, the merchant acquirer computer system 280, and a credit card and issuer computer systems 282.

The consumer uses a single point-of-sale instrument to pay for an item that the consumer wishes to purchase. The point-of-sale instrument may for example be a credit card, a bank card or a Near Field Communication (NFC) device. The point-of-sale instrument includes a single 16 digit PAN. The first six digits of the PAN are an issuer identification number (IIN). The first digit of the IIN is a major industry identifier (MII). The last ten digits of the PAN comprise an individual account identifier (IAI).

The consumer uses the point-of-sale instrument to communicate with the point-of-sale device 278. The point-of-sale device 278 receives the PAN from the point-of-sale instrument. In the case where the point-of-sale instrument is a credit card or a bank card, the PAN is located on a magnetic strip and the point-of-sale device is a device that has a magnetic strip reader. In the example where the point-of-sale instrument is an NFC device, the point-of-sale device 278 communicates with the point-of-sale instrument through electromagnetic waves to receive the PAN.

The point-of-sale device 278 transmits a charge request 284 to the merchant acquirer computer system 280. The charge request 284 includes the PAN, the terminal number of the point-of-sale device 278 and the total price of all the items.

FIG. 11A illustrates details of the transaction processing system 406, including a transaction receiving and confirmation module 430, a decision module 432, a PAN list checking module 434, a charge processing module 436, a charge forwarding module 438, a charge confirmation receiving module 440, a discount processing module 442, a reserve checking module 444, a reserve forwarding module 446, a reserve confirmation receiving module 448, a discount checking module 450, a discount receiving module 452 and a charge calculation module 454.

The charge request 284 is received from the point-of-sale device 278 by the transaction receiving and confirmation module 430. The charge request 284 is typically an International Standards Organization (ISO) 8583 message type indicator 200. For purposes of discussion, the charge request 284 includes the PAN serving as a consumer account identifier, the terminal number of the point-of-sale device 278, and a charge amount of $10.

The decision module 432 then decides whether the transaction processing system 406 should operate in a standard mode or in a discount checking mode. The decision module 432 utilizes the PAN received in the charge request 284 through the transaction receiving and confirmation module 430 and provides the PAN to the PAN list checking module 434. The PAN list checking module 434 then compares the PAN received from the decision module 432 with all PANs within the PAN list 416. The PAN list checking module 434 thus checks whether the PAN received from the decision module 432 exists within the PANs in the PAN list 416. If the PAN received from the decision module 432 exists within the PANs of the PAN list 416, the PAN is considered to be active within the PAN list 416. If the PAN does not exist within the PAN list 416, the PAN is considered to be not active in the PAN list 416. The PAN list checking module 434 then reports back to the decision module 432 with an indication whether the PAN is active or not active within the PAN list 416. If the PAN is not active within the PAN list 416, the decision module 432 operates the transaction processing system 406 in standard mode as illustrated in FIG. 11A. If the PAN is active within the PAN list 416, the decision module 432 operates the transaction processing system 406 in discount checking mode as illustrated in FIG. 11B.

Referring specifically to FIG. 11A, which illustrates the transaction processing system 406 operating in standard mode, the decision module 432 provides the charge request 284 to the charge processing module 436. The charge processing module 436, in turn, provides the charge request 284 to the charge forwarding module 438. The charge forwarding module 438 then transmits a charge request 286 via the network interface device of the merchant acquirer computer system 280 and over a network to the credit card and issuer computer systems 282. Because the transaction processing system 406 operates in standard mode, the charge request 286 is an ISO 8583 message type indicator 200, and therefore the same as the charge request 284 received from the point-of-sale device 278. The charge request 286 includes the PAN received in the charge request 284 and the charge amount of $10 which has not been reduced by any discounts.

The credit card and issuer computer systems 282 then return a charge confirmation 364, which is received over the network and via the network interface device of the transaction processing system 406 by the charge confirmation receiving module 440. The credit card and issuer computer systems 282 only transmit the charge confirmation 364 if sufficient funds are shown to be available within the credit card and issuer computer systems 282. If insufficient funds are available, then the charge confirmation 364 is replaced by a charge rejection (not shown). Because the charge request 286 includes a charge amount of $10, a minimum amount of funds that should be available within the credit card and issuer computer systems 282 should be at least $10 in order to receive the charge confirmation 364 when operating in standard mode. When operating in standard mode the charge confirmation 364 is an ISO 8583 message type indicator 210.

The charge confirmation receiving module 440 passes the charge confirmation 364 on to the transaction receiving and confirmation module 430. The transaction receiving and confirmation module 430 then transmits a confirmation 366 via the network interface device of the merchant acquirer computer system 280 and over the network to the point-of-sale device 278. The charge confirmation 366 is also an ISO 8583 message type indicator 210. The charge confirmation 366 includes a confirmation that sufficient funds are available for the charge amount of $10. The confirmation 366 will however be replaced by a charge rejection if insufficient funds are available.

The transaction receiving and confirmation module 430 is also connected to the transaction details data store 504 in FIG. 4. When the transaction receiving and confirmation module 430 receives the charge confirmation from the charge confirmation receiving module 440, the transaction receiving and confirmation module 430 also stored details of the transaction within the transaction details data store 504. Referring specifically to FIG. 4, the transaction details data store 504 can then either transmit details of the transaction as the bulk data 512 or as the consumer transaction data 520 to the server computer system 12.

Reference is now made to FIG. 11B which illustrates the operation of the transaction processing system 406 in discount checking mode. As mentioned, the decision module 432 determines whether the PAN received in the charge request 284 is active within the PAN list 416. If the PAN is active within the PAN list 416, the decision module 432 does not immediately invoke the charge processing module 436 as described with reference to FIG. 11A. Instead, the decision module 432 invokes the discount processing module 442. The decision module 432 will invoke the discount processing module 442 if the PAN received in the charge request 284 matches either one of the PANs 303A or B in FIG. 3.

The discount processing module 442 first invokes the operation of the reserve checking module 444. The reserve checking module 444 provides both the PAN and the charge amount, in the present example $10, to the reserve forwarding module 446. The reserve forwarding module 446 then transmits a reserve request 460 over the network interface device and the network to the credit card and issuer computer systems 282. In discount checking mode, the reserve request 460 is typically an ISO 8583 message type indicator 100. The reserve request 460 includes the PAN received in the charge request 284 and the charge amount of $10 which has not been reduced by any discount.

The credit card and issuer computer systems 282 then return a reserve confirmation 462 over the network and is received via the network interface device of the merchant acquirer computer system 280 by the reserve confirmation receiving module 448. The credit card and issuer computer systems 282 only transmit the reserve confirmation 462 if sufficient funds are shown to be available within the credit card and issuer computer systems 282. If insufficient funds are available within the credit card and issuer computer systems 282, the reserve confirmation 462 is replaced by a reserve rejection (not shown). In the present example, funds equal or more than the charge amount of $10 should be available within the credit card and issuer computer systems 282 in order to receive the reserve confirmation 462. In discount checking mode, the reserve confirmation 462 is typically an ISO 8583 message type indicator 110.

The reserve confirmation receiving module 448 then passes the reserve confirmation 462 on to the reserve checking module 444. The reserve checking module 444 then provides the reserve confirmation 462 on to the transaction receiving and confirmation module 430. The transaction receiving and confirmation module 430 then transmits a confirmation 466 over the network interface device of the merchant acquirer computer system 280 and the network to the point-of-sale device 278. The confirmation 466 is the same as the reserve confirmation 462 and is therefore also an ISO 8583 message type indicator 110. The confirmation 466 includes a confirmation that sufficient funds of at least $10 are available. The confirmation 466 will however be replaced by a reserve rejection if insufficient funds are available.

The reserve checking module 444 also reports back to the discount processing module 442. If the reserve confirmation 462 has been received, the discount processing module 442 invokes operation of the discount checking module 450. The discount processing module 442 however does not invoke the operation of the discount checking module 450 if a reserve rejection is received instead of a reserve confirmation 462.

The discount checking module 450 then transmits a discount checking call 468 over the network interface device of the merchant acquirer computer system 280 to a point-of-sale gateway 294 forming part of the transaction clearing system 40 shown in FIG. 1. The discount checking call 468 includes the PAN from the charge request 284 (which could match either PAN 303A or B in FIG. 3), a transaction identifier (ID), the terminal number of the point-of-sale device 278, a merchant account ID and the charge amount of $10 in the charge request 284. The merchant account ID is determined by the merchant acquirer computer system 280 by comparing a terminal number of the point-of-sale device 278 against a table that lists terminal numbers against merchant account ID's.

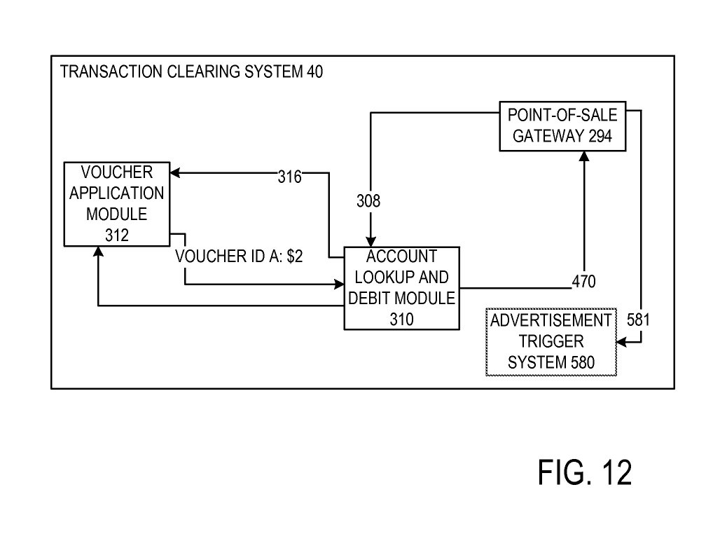

As shown in FIG. 12, the transaction clearing system 40 includes the point-of-sale gateway 294, an account lookup and debit module 310, a voucher application module 312 and an advertisement trigger system 580.

At 308, the point-of-sale gateway 294 provides a data set to an account lookup and debit module 310 forming part of the transaction clearing system 40, including the PAN, the terminal number, the amount, and the respective merchant account ID received in the discount checking call 468 of FIG. 11B.

The account lookup and debit module 310 receives the data set provided at 308 from the point-of-sale gateway 294. At 316, the account lookup and debit module 310 provides a data set to the voucher application module 312, including the PAN, terminal number, amount and merchant account ID. Referring again to FIG. 8, at 318 the voucher application module 312 provides a data set to the voucher management system 42 corresponding to the data set received from the account lookup and debit module 310 at 316. The purpose of the voucher application module 312 is to determine if, and if so, which voucher discounts may apply to the items identified in the data set received at 316. The voucher redemption system 198 includes a voucher lookup module 320, a voucher availability module 322 and a voucher cancel module 324.

The voucher lookup module 320 receives the data transmitted at 318 from the voucher application module 312. The voucher lookup module 320 then uses the data received at 318 to determine whether the data matches the data in the voucher entries 168. In each case, both the merchant account ID and the terminal number received in the data 318 are used to determine which ones of the voucher entries 168 have merchant account ID's 130 and matching terminal numbers 170.

The voucher lookup module 320 subsequently retrieves a set of data from an identified voucher entry 168, including the discount 174, in the present example $2, the voucher ID 184 and the total number available 176. The voucher lookup module 320 then makes a determination whether the total number available 176 of the respective voucher entry 168 is more than zero, in which case and only in that case, is the voucher entry 168 still valid. The voucher lookup module 320 also retrieves the merchant account ID 130. For purposes of further discussion, the voucher ID 184 of the identified voucher entry 168 is still valid and referred to herein as “voucher ID B.”

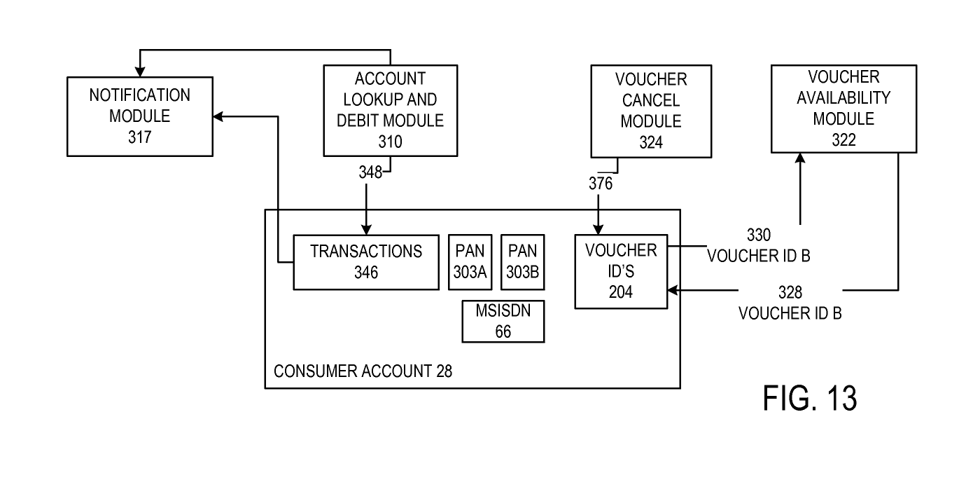

The voucher lookup module 320 at 326 submits the voucher ID of the identified voucher entry 168, now referred to as “voucher ID B” to the voucher availability module 322. Referring now to FIG. 13, the voucher availability module 322 at 328 determines whether voucher ID B is still valid within the voucher ID's 204 of the respective consumer account 28. Voucher ID B may for example not be valid, either because it has previously been used or the particular consumer account 28 having the MSISDN 66 has not been targeted by a merchant. In the present example, voucher ID B is found within the voucher ID's 204 and is determined to be valid. At 330, voucher ID B that is determined to be valid is returned to the voucher availability module 322.

Referring again to FIG. 8, the voucher lookup module 320 retrieves voucher ID B from the voucher availability module 322 because it is valid. At 334 the voucher lookup module 320 submits the voucher ID B together with its associated discount, in the present example $2, in a data set to the voucher application module 312. The data set received at 334 by the voucher application module 312 also includes the respective merchant account ID 130 retrieved by the voucher lookup module 320. At 372 the account lookup and debit module 310 initiates action by the voucher cancel module 324 to reduce the total number available 176 by one.

Referring again to FIG. 12, the voucher application module 312 subsequently provides the voucher ID and the discount of $2 to the account lookup and debit module 310. The account lookup and debit module 310 at 470 returns the amount of $2 to the point-of-sale gateway 294. Referring again to FIG. 11B, the point-of-sale gateway 294 transmits a response 472 over a network interface device of the server computer system 12 (FIG. 1) and the network and is received via the network interface device of the merchant acquirer computer system 280 by the discount receiving module 452. The discount checking call 468 and the response 472 include identical transaction ID's so that the transaction processing system 406 knows that the response 472 is in response to the discount checking call 468. Response 472 also includes the discount, in the present example $2.

The discount receiving module 452 provides a discount, in the present example $2, to the charge calculation module 454. The charge calculation module 454 receives the charge amount of $10 from the transaction receiving and confirmation module 430. The charge calculation module 454 then calculates a discounted amount of $8 by subtracting the discount amount of $2 from the charge amount of $10. The charge calculation module 454 then reports the discounted amount of $8 to the charge processing module 436.

The charge processing module 436 provides the discounted amount $8 to the charge forwarding module 438. The charge forwarding module 438 then submits a charge request 474 via the network interface device of the merchant acquirer computer system 280 and the network to the credit card and issuer computer systems 282. The charge request 474 is typically and ISO 8583 message type indicator 220. The charge request 474 includes the PAN of the charge request 284 and the discount amount of $8.

The credit card and issuer computer systems 282 subsequently return a charge confirmation 476 over the network and is received over network interface device of the merchant acquirer computer system 280 by the charge confirmation receiving module 440. Because the charge request has a charge amount of $8, which is less than the $10 of the reserve confirmation 462, the charge confirmation 476 is typically never replaced by a charge rejection. A charge rejection will only be received if a long period of time has passed since receiving the reserve confirmation 462, which will typically not happen within the time frames required for communicating with the point-of-sale gateway 294 and retrieving the discount amount. Once the charge confirmation receiving module 440 has received the charge confirmation 476, it is recorded for later settlement between the merchant acquirer computer system 280 and the credit card and issuer computer systems 282. The charge confirmation 476 is typically and ISO 8583 message type indicator 230.

An example is provided where an interception point is created within the merchant acquirer computer system 280 and the merchant acquirer computer system 280 then communicates with the credit card and issuer computer systems 282. The interception point may alternatively be created within a credit card or an issuer computer system. In the present example, the merchant acquirer computer system 280 is a first network computer system and the credit card and issuer computer systems 282 serve as a second network computer system. In an alternate embodiment, the credit card computer system may be the first network computer system, in which case the issuer computer system will be a second network computer system such that the interception point is created at the credit card computer system and charge and reserve requests and confirmations are communicated between the credit card and issuer computer systems. In a further embodiment, the network computer system may be an issuer computer system and the interception point is created within the issuer computer system for checking a list of consumer account identifier's in the form of PANs, MSISDN's, email addresses, social security numbers and the like.

Referring again to FIG. 13, at 348, the account lookup and debit module 310 utilizes the PAN received at 308 to identify the respective consumer account 28 having a PAN 303A or B matching the PAN received at 308. For example, if the PAN received at 348 matches the PAN 303A, the account lookup and debit module 310 will identify the respective consumer account 28. Similarly, if the PAN received at 348 matches the PAN 303B, the account lookup and debit module 310 will identify the consumer account 28. The consumer account 28 also has a set of previous transactions 346. At 348, the account lookup and debit module 310 records the respective transaction within the transactions 346.

The voucher cancel module 324 proceeds at 376 to cancel the respective voucher ID's from the voucher ID's 204 in the consumer account 28. In one example, there may be only one voucher ID B among the voucher ID's 204 and only the single voucher ID B is cancelled. In another example, the voucher ID may have two or more numbers associated therewith, and only a single number is deducted from the numbers for voucher ID B, such that further numbers of the voucher ID are available until the number reaches zero. As further illustrated in FIG. 8, the voucher cancel module 324 at 374 reduces the respective number within the total number available 176 of the respective voucher entry 168.

As mentioned, the transaction is recorded within the transactions 346. Referring again to FIG. 2, the transaction viewing module 220 downloads the transactions 346 of FIG. 13 as transactions 380 and displays the transactions 380 as transactions 382 within the interface 210.

Voucher entries have been used by way of example to illustrate offers and the way that they are redeemed. The voucher entries may for example correspond to item level discounts. Alternatively, basket level discounts may be provided wherein a discount is given based on an entire purchase of a plurality of items as opposed to individual items of the purchase. It may also be possible that offers may be extended that are not redeemable at server level for any discounts, such as coupons that can be redeemed at a point of sale or advertisements.

As further illustrated in FIG. 13, the account lookup and debit module 310 initiates action by a notifications module 317 to transmit an Short Message Service (SMS) message to the mobile device 24 in FIG. 2. The mobile device 24 includes the notifications module 218 that receives the notification as a notification 302. The notification 302 received by the notifications module 317 is displayed as a notification 304 within the interface 210.

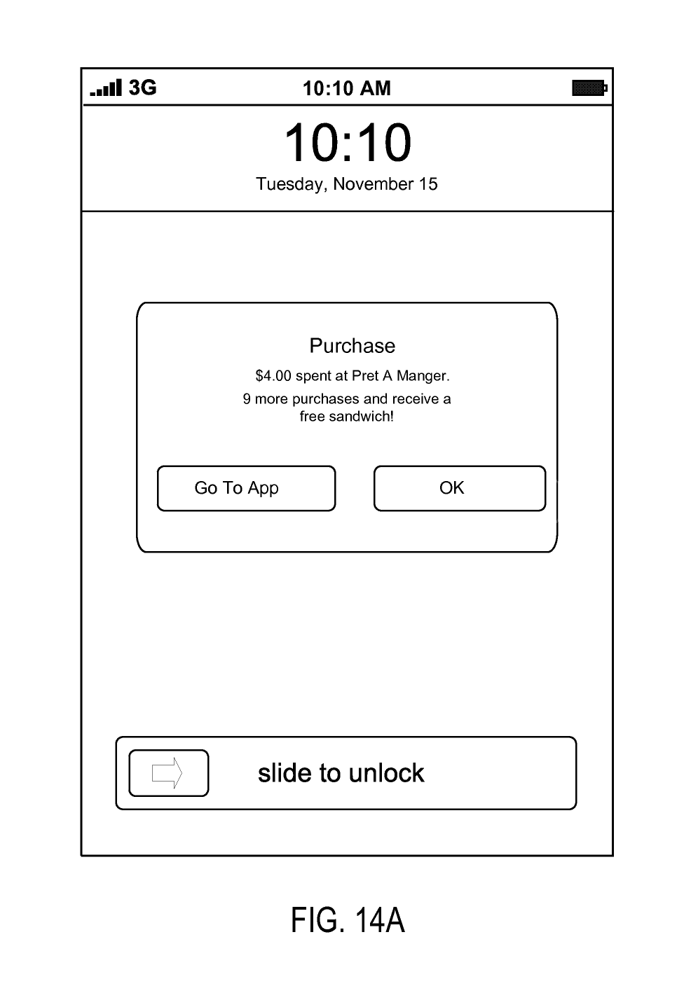

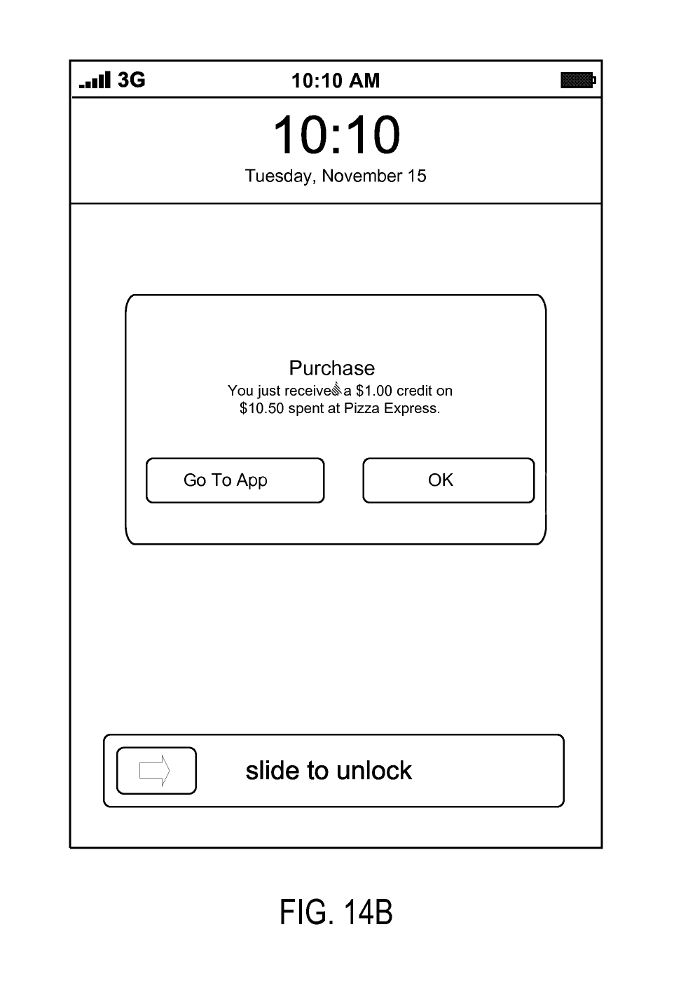

FIG. 14A indicates a charge of $4.00. The notification 304 also includes text displayed to the consumer indicating that nine more purchases will result in a discount for a free sandwich. In FIG. 14B, a notification 304 is received and displayed to the consumer, indicating a charge of $10.50 and that a credit of $1.00 has been applied.

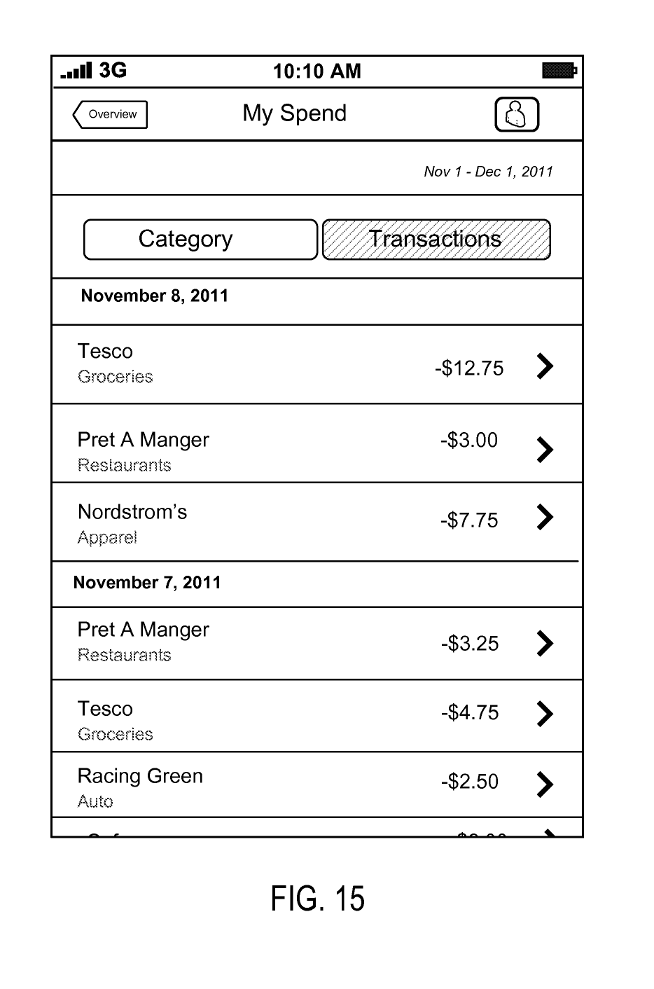

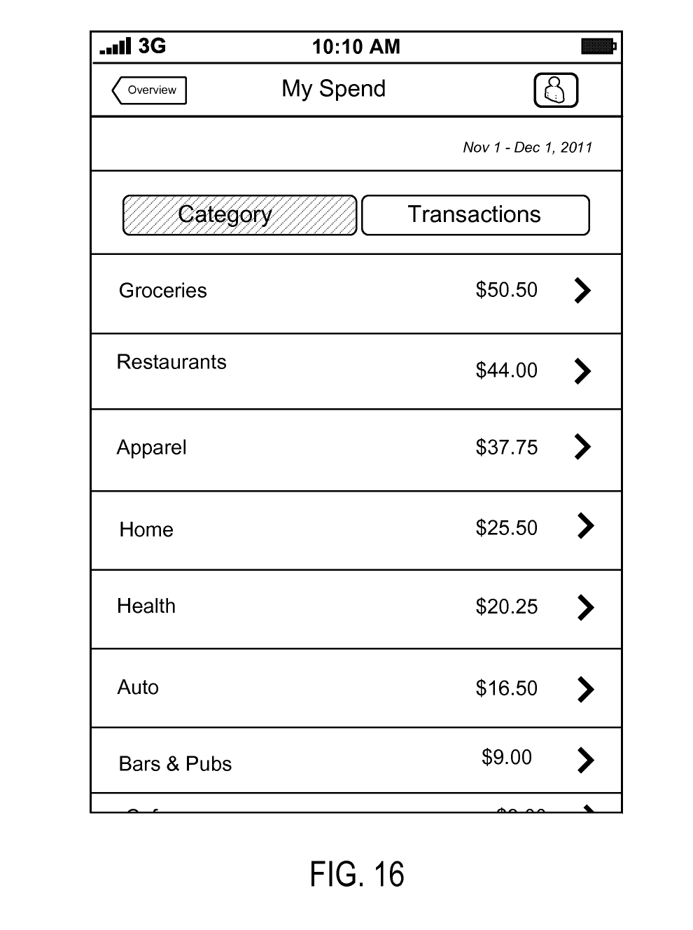

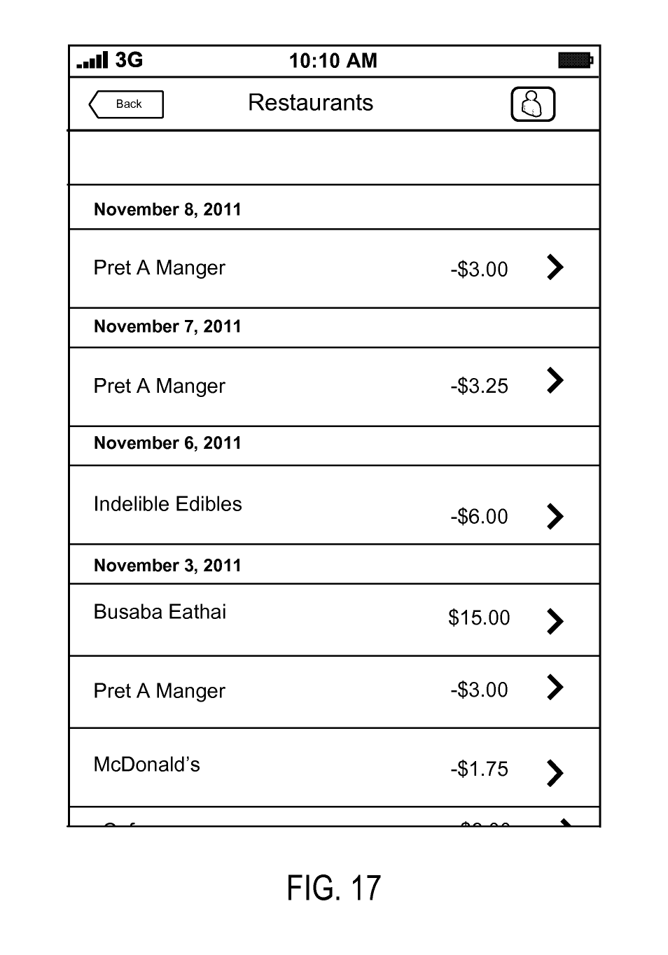

Should the consumer then open the mobile application 208 in FIG. 2, a view such as in FIG. 5G is displayed to the consumer. Selecting the link next to the Transactions, will take the consumer to the view of FIG. 15 wherein details of all transactions are displayed. The transactions displayed in FIG. 15 thus correspond to the transactions 382 in FIG. 2. FIG. 15 also provides a link for the consumer to view categories of transactions. Should the consumer select the link for categories, a view such as in FIG. 16 is displayed to the consumer. Should the consumer then select one of the categories, for example the category for “Restaurants”, a view such as in FIG. 17 is displayed. In FIG. 17, transactions categorized as “Restaurants” are displayed to the consumer.

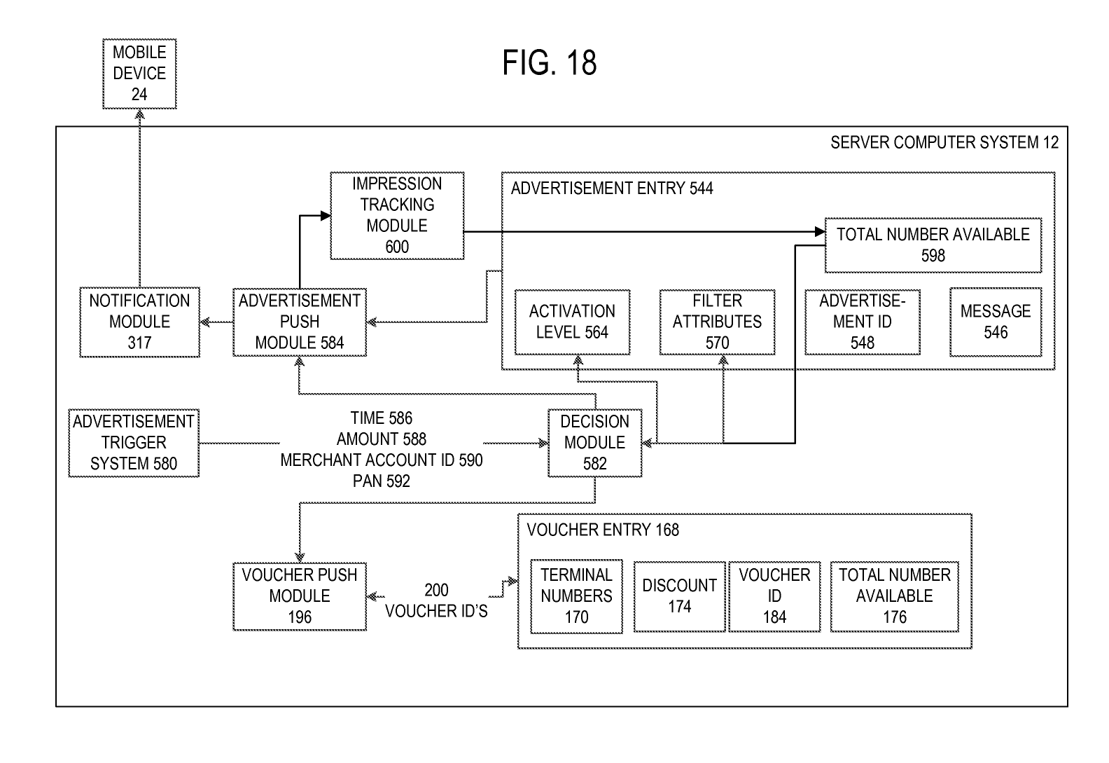

As shown in FIG. 12, the point-of-sale gateway 294 subsequently, at 581, initiates action by the advertisement trigger system 580. FIG. 18 illustrates components of the server computer system 12 that are used for sending an advertisement or a voucher to the mobile device 24 based on the advertisement trigger system 580, including a decision module 582 and an advertisement push module 584. The decision module 582 is connected to the advertisement trigger system 580 to receive the time 586, amount 588, merchant account ID 590 and PAN 592 of the transaction that has been processed through the point-of-sale gateway 294 in FIG. 12. The decision module 582 then utilizes the merchant account ID 590 to identify particular voucher entries 168 and advertisement entries 544 of a merchant account having a merchant account ID corresponding to the merchant account ID 590. The decision module 582 also utilizes the PAN 592 to determine whether there is a filter attribute 570 for a particular consumer having the PAN 592. The decision module 582 also compares the time 586 and amount 588 to any filter attributes for the transaction time or amount within the filter attributes 570. Only if all the filter attributes 570 are satisfied by the time 586, amount 588, and PAN 592 is a particular advertisement entry 544 identified for transmission to a consumer device in the form the mobile device 24. The decision module 582 may identify multiple advertisement entries 544 in more than one merchant account that have filter attributes 570 satisfying the data received from the advertisement trigger system 580. The decision module 582 then compares the activation level 564 of all the advertisement entries 544 that have been identified to determine which advertisement entry 544 to transmit to the mobile device 24 or in which order the advertisement entries 544 are to be transmitted to the mobile device 24. In the present example, the activation level 564 is the price 562 in FIG. 6 and the advertisement entry 544 with the highest price will be transmitted first to the mobile device 24.

The decision module 582 also determines whether a voucher entry 168 should be transmitted to the mobile device 24 instead of an advertisement entry. Should no advertisement entries be identified having desired filter attributes, then the decision module 582 may decide to instead transmit a voucher entry 168 to the mobile device 24. The voucher entry 168 is transmitted to the mobile device 24 using the voucher push module 196 as hereinbefore described.

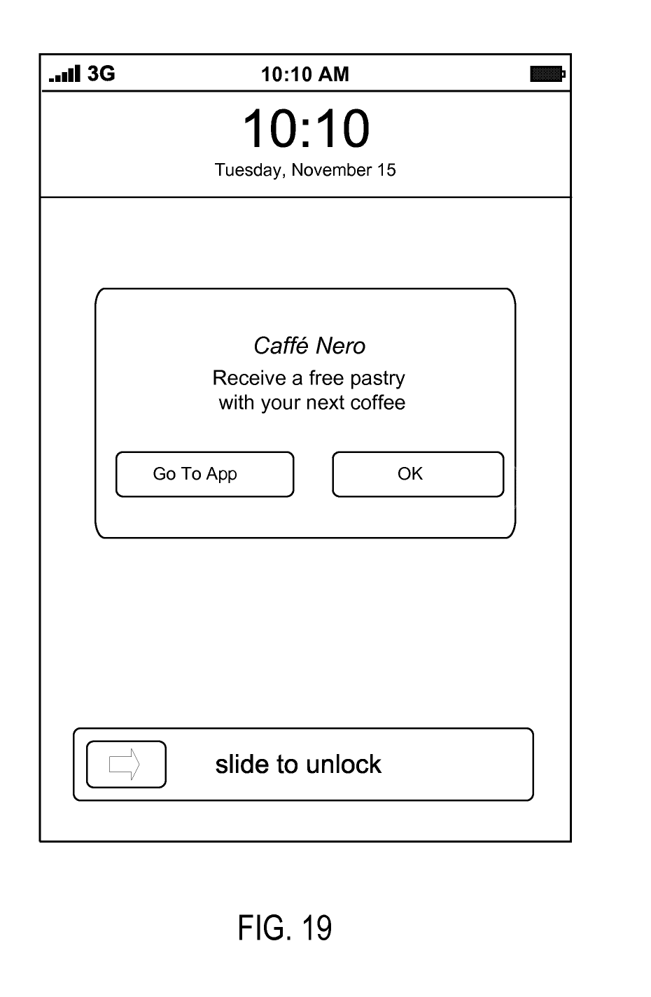

If the decision module 582 has identified an advertisement entry 544 for transmission to the mobile device 24, then the decision module 582 initiates functionality of the advertisement push module 584. The advertisement push module 584 then transmits the message 546 to the notification module 317 while bypassing all consumer accounts. The notification module 317 then transmits the message 546 to the mobile device 24. FIG. 19 illustrates an example of a message that is displayed on the display of the mobile device 24 following the discount checking call.

The server computer system 12 also includes an impression tracking module 600. The present example is an example of a “Cost Per Impression,” also referred to as “Cost Per Mille” or “CPM”. The impression tracking module 600 responds to the advertisement push module 584 to immediately reduce the total number of available 598 by 1. Before the decision module 582 initiates action by the advertisement push module 584, the decision module 582 determines whether the total number available 598 equals 1 or more. If the total number available 598 has been reduced to zero, the decision module 582 does not initiate action by the advertisement push module 584.

In a further alternative, a “Cost Per Click” or “CPC” system can be used. In a CPC system, the mobile application 208 in FIG. 2 has a viewing detector module that detects when a consumer selects an advertisement. The viewing detector module then stores the viewing of the advertisement and its advertisement ID within a memory of the mobile device 24. When the mobile device 24 is connected to a network such as a mobile phone data network or a Wireless Lan Network, the viewing detector module transmits the advertisement ID to the server computer system 12 in FIG. 18. A click tracking module similar to the impression tracking module 600 receives the advertisement ID and reduces the total number available similar to the total number available 598 by 1.

The server computer system 12 can make provision for both a CPM and a CPC model at the same time. A view similar to FIG. 7H can be displayed to the merchant wherein the merchant can select either a CPM or CPC model. The advertisement entry 544 is thus transmitted based on bidding on the data in the target profile attribute system 531 in FIG. 6, and the data of the target profile attribute system 531 is based on the transaction data in the profiles 518 and 530 in FIG. 4 deriving from the offer network integration unit 502 in FIG. 4.

### 5). Computer System

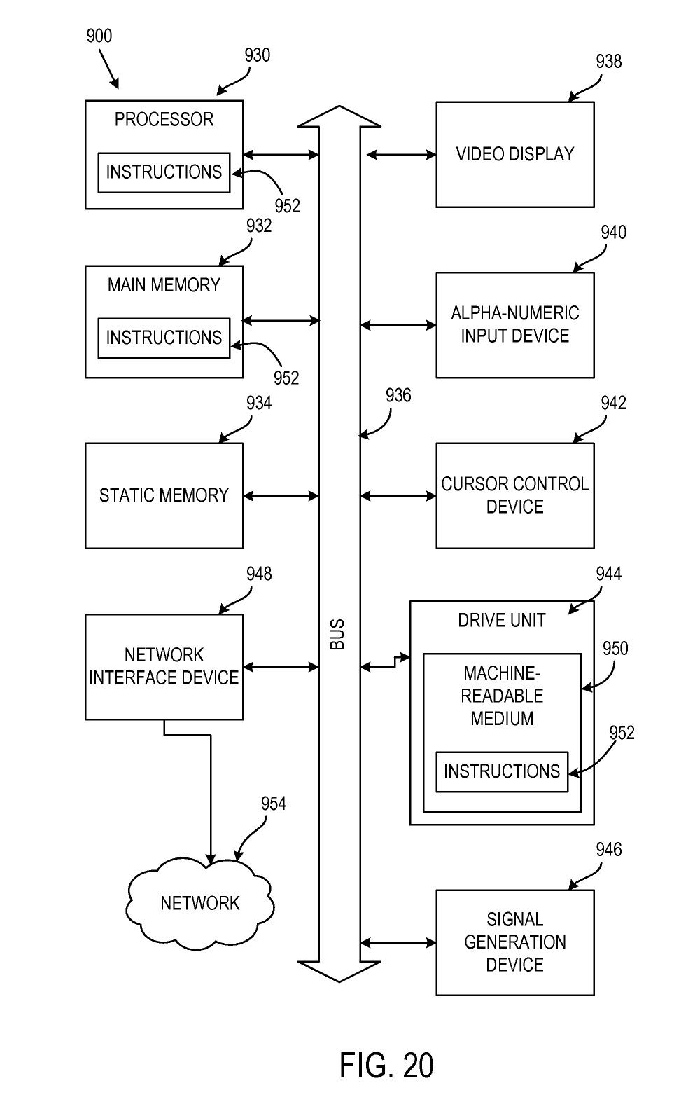

FIG. 20 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal display (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While the instructions 952 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

### 6). Mobile Device

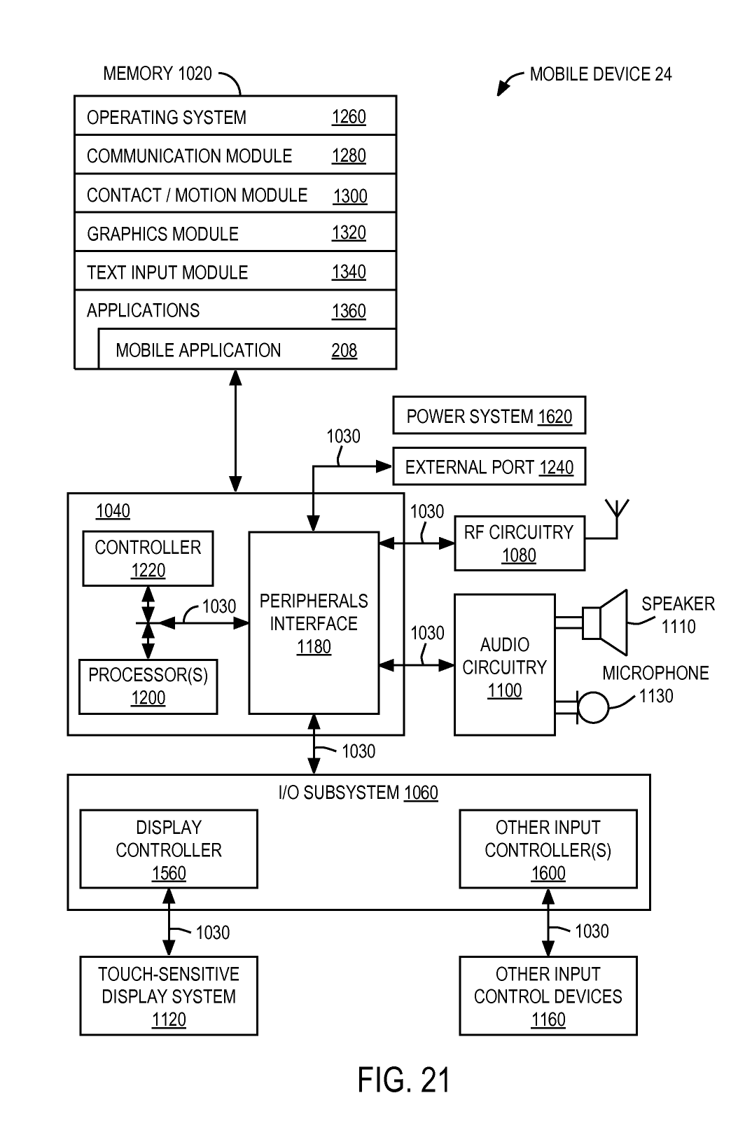

FIG. 21 is a block diagram illustrating the mobile device 24, illustrating a touch-sensitive display 1120 or a “touch screen” for convenience. The mobile device 24 includes a memory 1020 (which may include one or more computer readable storage mediums), a memory controller 1220, one or more processing units (CPU's) 1200, a peripherals interface 1180, RF circuitry 1080, audio circuitry 1100, a speaker 1110, a microphone 1130, an input/output (I/O) subsystem 1060, other input or control devices 1160 and an external port 1240. These components communicate over one or more communication buses or signal lines 1030.

The various components shown in FIG. 21 may be implemented in hardware, software or a combination of both hardware and software, including one or more signal processing and/or application specific integrated circuits.

The memory 1020 may include high-speed random access memory and may also include non-volatile memory, such as one or more magnetic disk storage devices, flash memory devices, or other non-volatile solid-state memory devices. Access to the memory 1020 by other components of the mobile device 24, such as the CPU 1200 and the peripherals interface 1180, is controlled by the memory controller 1220.

The peripherals interface 1180 connects the input and output peripherals of the device to the CPU 1200 and memory 1020. The one or more processors 1200 run or execute various software programs and/or sets of instructions stored in the memory 1020 to perform various functions for the mobile device 24 and to process data.

The RF (radio frequency) circuitry 1080 receives and sends RF signals, also called electromagnetic signals. The RF circuitry 1080 converts electrical signals to/from electromagnetic signals and communicates with communications networks and other communications devices via the electromagnetic signals. The RF circuitry 1080 includes well-known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The RF circuitry 1080 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies that are known in the art.

The audio circuitry 1100, the speaker 1110, and the microphone 1130 provide an audio interface between a user and the mobile device 24. The audio circuitry 1100 receives audio data from the peripherals interface 1180, converts the audio data to an electrical signal, and transmits the electrical signal to the speaker 1110. The speaker 1110 converts the electrical signal to human-audible sound waves. The audio circuitry 1100 also receives electrical signals converted by the microphone 1130 from sound waves. The audio circuitry 1100 converts the electrical signal to audio data and transmits the audio data to the peripherals interface 1180 for processing. The audio circuitry 1100 also includes a headset jack serving as an interface between the audio circuitry 1100 and removable audio input/output peripherals, such as output-only headphones or a headset with both output (e.g., a headphone for one or both ears) and input (e.g., a microphone).

The I/O subsystem 1060 connects input/output peripherals on the mobile device 24, such as the touch screen 1120 and other input/control devices 1160, to the peripherals interface 1180. The I/O subsystem 1060 includes a display controller 1560 and one or more input controllers 1600 for other input or control devices. The one or more input controllers 1600 receive/send electrical signals from/to other input or control devices 1160. The other input/control devices 1160 may include physical buttons (e.g., push buttons, rocker buttons, etc.), dials, slider switches, joysticks, click wheels, and so forth all serving as forming part of an interface. The input controllers 1600 may be connected to any of the following: a keyboard, infrared port, USB port, and a pointer device such as a mouse. The one or more buttons may include an up/down button for volume control of the speaker 1110 and/or the microphone 1130. The one or more buttons may include a push button. A quick press of the push button may disengage a lock of the touch screen 1120 or begin a process that uses gestures on the touch screen to unlock the device. A longer press of the push button may turn power to the mobile device 24 on or off. The touch screen 1120 is used to implement virtual or soft buttons and one or more soft keyboards.

The touch-sensitive touch screen 1120 provides an input interface and an output interface between the device and a user. The display controller 1560 receives and/or sends electrical signals from/to the touch screen 1120. The touch screen 1120 displays visual output to the user. The visual output may include graphics, text, icons, video, and any combination thereof (collectively termed “graphics”). In some embodiments, some or all of the visual output may correspond to user-interface objects, further details of which are described below.

A touch screen 1120 has a touch-sensitive surface, sensor or set of sensors that accepts input from the user based on haptic and/or tactile contact. The touch screen 1120 and the display controller 1560 (along with any associated modules and/or sets of instructions in memory 1020) detect contact (and any movement or breaking of the contact) on the touch screen 1120 and converts the detected contact into interaction with user-interface objects (e.g., one or more soft keys, icons, web pages or images) that are displayed on the touch screen. In an exemplary embodiment, a point of contact between a touch screen 1120 and the user corresponds to a finger of the user.

The touch screen 1120 may use LCD (liquid crystal display) technology, or LPD (light emitting polymer display) technology, although other display technologies may be used in other embodiments. The touch screen 1120 and the display controller 1560 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1120.

The user may make contact with the touch screen 1120 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

The mobile device 24 also includes a power system 1620 for powering the various components. The power system 1620 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The software components stored in memory 1020 include an operating system 1260, a communication module (or set of instructions) 1280, a contact/motion module (or set of instructions) 1300, a graphics module (or set of instructions) 1320, a text input module (or set of instructions) 1340, and applications (or set of instructions) 1360.

The operating system 1260 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 1280 facilitates communication with other devices over one or more external ports 1240 and also includes various software components for handling data received by the RF circuitry 1080 and/or the external port 1240. The external port 1240 (e.g., Universal Serial Bus (USB), FIREWIRE, etc.) is adapted for coupling directly to other devices or indirectly over a network (e.g., the Internet, wireless LAN, etc.).

The contact/motion module 1300 may detect contact with the touch screen 1120 (in conjunction with the display controller 1560) and other touch sensitive devices (e.g., a touchpad or physical click wheel). The contact/motion module 1300 includes various software components for performing various operations related to detection of contact, such as determining if contact has occurred, determining if there is movement of the contact and tracking the movement across the touch screen 1120, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). The contact/motion module 1300 and the display controller 1560 also detects contact on a touchpad.

The graphics module 1320 includes various known software components for rendering and displaying graphics on the touch screen 1120, including components for changing the intensity of graphics that are displayed. As used herein, the term “graphics” includes any object that can be displayed to a user, including text, web pages, icons (such as user-interface objects including soft keys), digital images, videos, animations and the like.

The text input module 1340, which may be a component of graphics module 1320, provides soft keyboards for entering text in various applications (e.g., contacts, e-mail, IM, blogging, browser, and any other application that needs text input). The applications 1360 may include the mobile application 208.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A computer system for managing electronic transactions, comprising:
a server computer system including:
a processor;
a computer-readable medium connected to the processor;
a network interface device connected to the processor; and
a set of instructions on the computer-readable medium, the set of instructions being executable by the processor and including:
a data store;
a consumer account setup module that receives a plurality of first card numbers over the network interface device and stores each respective first card number in the data store in association with a respective consumer account;
a communication and routing module that receives a charge advisory over the network interface device, the charge advisory including a charge advisory card number and identifies a selected one of the consumer accounts by associating one of the first card numbers with the charge advisory card number; and
a transaction processing system that processes the charge advisory based on an account detail of the selected consumer account.

2. The computer system of claim 1, wherein the set of instructions further includes:
a mobile application transmitted over the network interface device for installation on a mobile device of a consumer, the mobile application receiving the first card number and transmitting the first card number for receipt over the network interface device by the processor.

3. The computer system of claim 2, wherein the mobile application has an interface for entering the first card number and a consumer account setup module that transmits the first card number.

4. The computer system of claim 2, further comprising:
a notification module transmitting a message over the network interface device to the mobile device based on an identifier in the consumer account having the consumer account identifier, the message being transmitted in response to the processing of the charge advisory.

5. The computer system of claim 4, wherein the identifier is a phone number.

6. The computer system of claim 1, wherein the consumer account setup module receives a plurality of second card numbers over the network interface device and stores each respective second card number in the data store in association with a respective consumer account, such that the respective consumer account has a respective first card number and a respective charge advisory card number associated therewith, wherein the processor is capable of identifying a selected one of the consumer accounts by associating one of the second card numbers with the charge advisory card number and processing the charge advisory based on an account detail of the selected consumer account.

7. The computer system of claim 6, further comprising:
a mobile application transmitted over the network interface device for installation on a mobile device of a consumer, the mobile application receiving the first and second card numbers and transmitting the first and second card numbers for receipt over the network interface device by the processor.

8. The computer system of claim 7, wherein the mobile application has an interface for entering the first and second card numbers and a consumer account setup module that transmits the first and second card numbers.

9. The computer system of claim 2, further comprising:
a plurality of merchant accounts stored in the data store, each merchant account having a merchant account identifier;
an interface for the merchant account, the interface for the merchant account being transmitted over the network interface device to a merchant computer system, the interface for the merchant account allowing for entry of a merchant offer into the merchant interface and transmission of the merchant offer, the merchant offer being received from the merchant computer system over the network interface device, the merchant offer being stored in the data store in association with the merchant account having the respective merchant account identifier, the merchant offer being transmitted over the network interface device; and
a voucher redemption system matching the second merchant account identifier to one of the first merchant account identifiers to identify a selected one of the voucher entries associated with the merchant account having the first merchant account identifier, wherein the processing of the charge advisory includes processing of the selected voucher entry.

10. The computer system of claim 9, further comprising:
a push module associating the merchant offer with the consumer account, the processor processing the merchant offer based on the association of the merchant offer with the consumer account identifier.

11. A computer-based method of managing electronic transactions, comprising:
receiving, with a processor, a plurality of first card numbers over a network interface device;
storing, with the processor, each respective first card number in a data store in association with a respective consumer account;
receiving, with the processor, a charge advisory over the network interface device, the charge advisory including a charge advisory card number;
identifying, with the processor, a selected one of the consumer accounts by associating one of the first card numbers with the charge advisory card number; and
processing, with the processor, the charge advisory based on an account detail of the selected consumer account.

12. The method of claim 11, further comprising:
transmitting a mobile application over the network interface device for installation on a mobile device of a consumer, the mobile application receiving the first card number and transmitting the first card number for receipt over the network interface device by the processor.

13. The method of claim 12, wherein the mobile application has an interface for entering the first card number and a consumer account setup module that transmits the first card number.

14. The method of claim 12, further comprising:
transmitting a message over the network interface device to the mobile device based on an identifier in the consumer account having the consumer account identifier, the message being transmitted in response to the processing of the charge advisory.

15. The method of claim 14, wherein the identifier is a phone number.

16. The method of claim 11, further comprising:
receiving, with the processor, a plurality of second card numbers over the network interface device; and
storing, with the processor, each respective second card number in the data store in association with a respective consumer account, such that the respective consumer account has a respective first card number and a respective charge advisory card number associated therewith, wherein the processor is capable of identifying a selected one of the consumer accounts by associating one of the second card numbers with the charge advisory card number and processing the charge advisory based on an account detail of the selected consumer account.

17. The method of claim 16, further comprising:
transmitting a mobile application over the network interface device for installation on a mobile device of a consumer, the mobile application receiving the first and second card numbers and transmitting the first and second card numbers for receipt over the network interface device by the processor.

18. The method of claim 17, wherein the mobile application has an interface for entering the first and second card numbers and a consumer account setup module that transmits the first and second card numbers.

19. The method of claim 12, further comprising:
storing, with the processor, a plurality of merchant accounts in the data store, each merchant account having a merchant account identifier;
transmitting, with the processor, an interface for the merchant account over the network interface device to a merchant computer system, the interface for the merchant account allowing for entry of a merchant offer into the merchant interface and transmission of the merchant offer;
receiving, with the processor, the merchant offer from the merchant computer system over the network interface device;
storing, with the processor, the merchant offer in the data store in association with the merchant account having the respective merchant account identifier;
transmitting, with the processor, the merchant offer over the network interface device to the mobile device; and
matching, with the processor, the second merchant account identifier to one of the first merchant account identifiers to identify a selected one of the voucher entries associated with the merchant account having the first merchant account identifier, wherein the processing of the charge advisory includes processing of the selected voucher entry.

20. The method of claim 19, further comprising:
associating, with the processor, the merchant offer with the consumer account; and
processing, with the processor, the merchant offer based on the association of the merchant offer with the consumer account identifier.
